(19) United States
(12) Patent Application Publication
(10) Pub. No.: US 2021/0350346 A1
(43) Pub. Date: Nov. 11, 2021

(54) SYSTEM AND METHOD FOR USING PASSIVE MULTIFACTOR AUTHENTICATION TO PROVIDE ACCESS TO SECURE SERVICES

(71) Applicant: Capital One Services, LLC, McLean, VA (US)

(72) Inventors: Joshua EDWARDS, McLean, VA (US); Abdelkader M'Hamed BENKREIRA, McLean, VA (US); Michael MOSSOBA, McLean, VA (US)

(73) Assignee: Capital One Services, LLC, McLean, VA (US)

(21) Appl. No.: 16/868,489

(22) Filed: May 6, 2020

(51) Int. Cl. G06Q 20/10; G06Q 20/38; G10L 17/18; G06N 3/08; G06K 9/00; G06K 9/62

(52) U.S. Cl. CPC G06Q 20/1085; G06Q 20/388; G06K 9/6215; G06N 3/08; G06K 9/00302; G10L 17/18

(57) ABSTRACT

Some embodiments may include causing a message to be output by a speaker of an interactive kiosk in response to detecting a user's presence in an environment of the interactive kiosk. First data representing a response to the message may be captured via at least one sensor of the interactive kiosk. Based on the first data and second data related to prior responses provided by one or more users, a similarity metric for each of the prior responses may be determined, where the similarity metric indicates a degree of similarity between the response and each of the prior responses. An account associated with the response may be determined based on one of the similarity metrics satisfying a predefined authentication condition, a account associated with response, and access to one or more services associated with the account may be provided via the interactive kiosk.

### FIELD

The present application relates to providing access to one or more secure services, including, for example, providing access to secure services based on user behaviors responsive to audio interactions.

### BACKGROUND

Human-machine interactions can vastly differ from human-human interactions. Generally, there is a range of expected responses a human will provide in response to an interaction from another human (e.g., a particular spoken reply to an utterance, a facial expression, etc.). Humans are usually able to recognize when another human acts inappropriately or unexpectedly in response to a spoken utterance. On the other hand, interactions between humans and machines are generally not as predictable as different individuals may respond to machines in different manners.

Due to the vast number of possible responses that a given human may provide when interacting with a computing device, identifying that human can becomes increasing complex. For a computing device implemented on an interactive kiosk, the inability to quickly and accurately identify a human may result in a poor end user experience. Traditionally, interactive kiosks identify a human based on authentication credentials actively provided by the human (e.g., via a credit card, PIN, etc.). However such traditional identification mechanisms require active steps performed by the user, as well as, or alternatively, requiring a user to retain their authentication credentials. This can add friction to the user's experience with the interactive kiosk, and also makes the user more susceptible to malicious activities as authentication credentials, credit cards, and the like may be stolen, replicated, or masked.

These and other drawbacks exist.

### SUMMARY

Aspects of the present application relate to methods, apparatuses, media, and/or systems for providing access to secure services.

In some embodiments, a message may be output by a speaker of an interactive kiosk in response to detecting a user's presence in an environment of the interactive kiosk, and data representing the user's response to the message may be captured by the interactive kiosk. Data related to prior responses provided by other users, as well as the user, may be obtained and a similarity metric indicating a degree of similarity between the user's response and the prior responses may be determined. If the similarity metric between the user's response and one or more of the prior responses satisfies a predefined authentication condition, an account associated with such prior responses (e.g., feature vectors representing the user's prior responses) may be determined, and access to one or more services of the account may be provided to the user.

Various other aspects, features, and advantages of the present application will be apparent through the detailed description of the present application and the drawings attached hereto. It is also to be understood that both the foregoing general description and the following detailed description are examples and not restrictive of the scope of the present application.

### BRIEF DESCRIPTION OF THE DRAWINGS

FIG. 1 shows a system for providing access to secure services, in accordance with one or more embodiments.

FIG. 2 shows an example of an interactive kiosk, in accordance with one or more embodiments.

FIG. 3 shows examples of candidate audio messages for output by an interactive kiosk, in accordance with one or more embodiments.

FIG. 4 shows an example of a response database storing data used to determine whether to provide access to secure services based on a user's response to an output audio message, in accordance with one or more embodiments.

FIG. 5 shows a flowchart of a method of determining whether to provide access to secure services via an interactive kiosk, in accordance with one or more embodiments.

FIG. 6 shows a flowchart of another method of determining whether to flag an account based on a captured response to an audio message, in accordance with one or more embodiments.

FIG. 7 shows a flowchart of yet another method for generating training data for a prediction model to be used for determining whether to provide access to secure services via an interactive kiosk, in accordance with one or more embodiments.

### DETAILED DESCRIPTION

In the following description, for the purposes of explanation, numerous specific details are set forth in order to provide a thorough understanding of the embodiments of the present application. It will be appreciated, however, by those having skill in the art that the embodiments of the present application may be practiced without these specific details or with an equivalent arrangement. In other cases, well-known structures and devices are shown in block diagram form in order to avoid unnecessarily obscuring the embodiments of the present application.

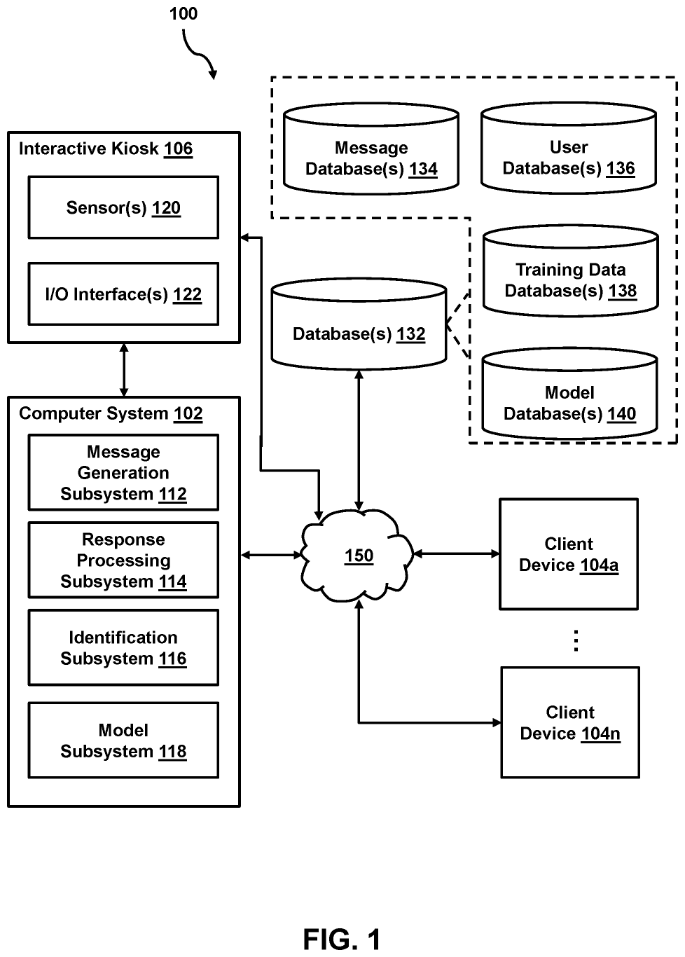

FIG. 1 shows a system 100 for providing access to one or more secure services, in accordance with one or more embodiments. As shown in FIG. 1, system 100 may include computer system 102, client device 104 (or client devices 104a-104n), interactive kiosk 106, or other components. Computer system 102 may include message generation subsystem 112, response processing subsystem 114, identification subsystem 116, model subsystem 118, and/or other components. Each client device 104 may include any type of mobile terminal, fixed terminal, or other device. By way of example, client device 104 may include a desktop computer, a notebook computer, a tablet computer, a smartphone, a wearable device, or other client device. Users may, for instance, utilize one or more client devices 104 to interact with one another, one or more servers, or other components of system 100. Interactive kiosk 106 may include one or more sensors 120, one or more input/output (I/O) interfaces 122, or other components. As an example, interactive kiosk 106 may include a microphone, a speaker, a display screen (e.g., a touch screen), a motion sensor, biometric sensors, retinal scanners, or other components. It should be noted that while one or more operations are described herein as being performed by particular components of computer system 102, those operations may, in some embodiments, be performed by other components of computer system 102 or other components of system 100. As an example, while one or more operations are described herein as being performed by components of computer system 102, those operations may, in some embodiments, be performed by components of client device 104, interactive kiosk 106, or both. It should also be noted that, although some embodiments are described herein with respect to machine-learning models, other prediction models (e.g., statistical models or other analytics models) may be used in lieu of or in addition to machine-learning models in other embodiments (e.g., a statistical model replacing a machine-learning model and a non-statistical model replacing a non-machine-learning model in one or more embodiments).

In some embodiments, system 100 may be configured to determine whether to provide a user access to one or more secure services via an interactive kiosk (e.g., interactive kiosk 106). Generally, human-machine interactions differ as compared to interactions between humans. For example, if a first individual utters “Good morning” to a second individual, the second individual will typically reply with a response, such as “good morning.” Generally, there is a range of expected responses from a human to an utterance from another human. Similarly, a human's facial expression when hearing and/or responding to an utterance from another human also typically falls within a range of expected facial expressions. Therefore, humans tend to recognize when another acts inappropriately or unexpectedly to a spoken utterance.

Interactions between humans and machines, however, are generally not as predictable. Different individuals may respond to machines in different manners. For example, some individuals may utter a response to an audio message output by a computing device, whereas other individuals may remain silent. As another example, some individuals may speak a robust utterance (e.g., including multiple words or sentences), whereas other users may speak a single word utterance (e.g., “Yes,” “No,” “Hi,” “Ok,” etc.). Furthermore, the mannerisms expressed by individuals when interacting with a computing device may vary.

Due to the vast number of possible responses—both verbal and behavioral—that a given human may provide when interacting with a computing device, identifying that human becomes increasing complex. For a computing device implemented on an interactive kiosk, such as an automated teller machine (ATM), such difficulties in identifying a human may result in a poor end user experience. For example, an ATM is unable to identify the human, the human may be unable to access their account, (e.g., a bank account), have their account frozen due to suspicious behavior, and the like. Traditionally, interactive kiosks (e.g., ATMs, interactive kiosks for checking in to a flight or train, accessing a secure facility, etc.) are configured to identify a human based on authentication credentials actively provided by the human. In some embodiments, the authentication credentials may be character strings (e.g., letters, numbers, or a combination thereof) that a user provides as an input to the interactive kiosk. For example, a user may input an account number of the user, a social security number of the user, a phone number of the user, an email of the user, or other information used to identify the user to an interactive kiosk for identification and/or authentication. In some embodiments, the authentication credentials may be stored by an item, which may be provided to the interactive kiosk for authentication. Such items may include, for example and without limitation, a credit card, an identification (ID) card, a key fob, a near field communication (NEC) card, or other device. For example, a user may input a credit card to an ATM (e.g., by swiping the credit card through a magnetic card reading device, inserting the credit card into a chip reader, etc.), and data stored by the card may be used to identify and/or authenticate the user. In some embodiments, the authentication credentials may include biometric data provided by the user to the interactive kiosk. For example, a user may scan a finger or palm using the interactive kiosk, have a retinal scan performed via the interactive kiosk, or use another form of biometric data.

The above-referenced techniques have some drawbacks in that a user may be required to remember his/her authentication credentials, keep his/her credit card or other identification item in possession at all times, and the like. Additionally, the need to manually input information in order to access services of the user's account can become time consuming for the user and increases vulnerabilities to malicious actors. For example, authentication credentials, credit cards, and the like may be stolen, thereby allowing malicious actors to access a user account's secure services. Furthermore, different biometric signals can be spoofed and used to fool computing devices, such as using patches to trick facial recognition functionalities.

Described herein are techniques for avoiding the aforementioned drawbacks while maintaining security, in particular for human-machine interactions. In some embodiments, an interactive kiosk or other computing system may be configured to use passive multifactor authentication to provide a user access to one or more secure services. Some embodiments may include causing, in response to detecting a user's presence within a predefined distance of an interactive kiosk, an audio message to be output by a speaker or other audio output device communicatively coupled to the interactive kiosk. For example, upon determining that a user has entered a vestibule where an ATM is located (e.g., via one or more motion sensors), an audio message may be output from a speaker of the ATM The message may be a generic greeting message, such as “Hello,” or “How are you doing?”, or the message may be customized to include additional authentication information determined based on features associated with the interactive kiosk. For example, based on location information regarding a location of the interactive kiosk, a weather forecast of the geographic region where the interactive kiosk is located may be accessed, and an audio message may be generated based on the current weather forecast (e.g., “Hello—what a beautiful day it is,” “Hope the rain isn't too much,” “Did it start snowing yet?”, etc.). Alternatively or additionally, temporal information may be used to customize the message based on a time of day. For instance, a first utterance (e.g., “Good morning!”) may be used as the audio message during morning hours, whereas a second utterance (e.g., “Good evening!”) may be used as the audio message during evening hours. Further still, the tone, volume, accent, gender, intonation, words, etc., may be adjusted based on a particular geographic region in which the interactive kiosk is determined to be.

As the audio message is output by the interactive kiosk, one or more sensors of the interactive kiosk may capture a response of the user to the audio message. In some embodiments, the response may include a spoken utterance from the user, which may be captured by one or more microphones of the interactive kiosk or in an environment of the interactive kiosk (e.g., within an ATM vestibule). For example, in response to the audio message “Hello” output from an ATM's speakers, a user may say “Hello” back. As another example, the user may not speak in response to the audio message. In some embodiments, the captured response may include a facial expression of the user during or after the audio message is output, which may be captured by one or more cameras of the interactive kiosk or in the environment of the interactive kiosk. For example, in response to the audio message, the user may smile, frown, express confusion, remain stagnant, or exhibit another expression.

The interactive kiosk may obtain prior response data related to prior responses provided by the user as well as, or alternatively, one or more other users, to previous audio messages. In some embodiments, the prior response data may be stored locally by the interactive kiosk or the prior response data may be retrieved upon the audio message being output. The prior responses may include various facial expressions and spoken replies from the other users, the user, or both. For instance, the prior responses may include audio data representing audio of previous responses to the same or similar audio message that has been output to the user. In some embodiments, the prior response data may include audio fingerprints (e.g., an acoustic fingerprint) representative of audio from a user in response to an output audio message. Still further, the prior response data may include text data representing text obtained by converting a spoken reply to an audio message into text. Additionally, the prior response data may include a feature vector indicating features of a facial expression exhibited by a user in response to an audio message. For example, the feature vector may be an N-dimensional vector in a continuous feature space representative of various facial features extracted from images captured of a user from a prior response to a previous audio message.

In some embodiments, the prior response data and the detected response may be compared to determine a similarity score. The similarity score may indicate how similar the detected response is to each of the prior responses to the previous audio messages. For example, a feature vector representing the facial expression of the user in response to the output audio message may be compared to feature vectors representing facial expressions of other users (as well as the user) expressed in prior responses to previous audio messages. As another example, a feature vector representing the captured audio of the user in response to the output audio message may be compared to feature vectors representing the spoken replies from the other users (as well as the user) to previous audio messages. In some embodiments, the similarity may be determined by computing a cosine distance, a Euclidean distance, or other feature space similarity metric, between each pair of feature vectors. In some embodiments, the feature vectors for both the spoken reply and the facial expression may be compared individually or in combination, as detailed below. Based on the similarities scores, a determination may be made as to whether any of the similarity scores satisfy a similarity score threshold. For example, the similarity score threshold may correspond to the Euclidean distance between two feature vectors being greater than a threshold value (e.g., f₁·f₂≥T). If so, an account associated with the prior response that “matched” the feature vector of the captured response may be selected, and secure services available for that account may be determined. The secure services may then be provided to the user at the interactive kiosk, thereby allowing the user to passively be identified using multiple forms of authentication without requiring the user to physically input any authentication credentials. For example, by passively identifying a user, the user may not be required to physically input any information, thereby reducing an amount of exposure of the user's private information (e.g., personal identification information, personal financial information) to nefarious sources. Additionally, by passively identifying a user, that user may reduce exposing themselves to biological contagions (e.g., bacteria, viruses, etc.) that inherently reside on publicly accessible surfaces (e.g., buttons, screens, door handles, etc.), decreasing the likelihood of spreading sicknesses and other illnesses. In some embodiments, if multiple accounts are determined to produce similarity scores that satisfy the similarity score threshold, a top scoring response may be selected or additional authentication information may be requested. As described herein, the term “similarity score” and “similarity metric” may be used interchangeably.

As shown in FIG. 1, interactive kiosk 106 may include a computing device or computing system configured with computer program instructions to facilitate the performance of one or more specialized tasks. In some embodiments, interactive kiosk 106 may be communicatively coupled to a general purpose computing device, a computer system (e.g., computer system 102), one or more client devices (e.g., client devices 104), one or more databases (e.g., databases 132), or other components. In some embodiments, interactive kiosk 106 may include one or more processors, memory, and communications components integrated therein. Various example interactive kiosks may include, but are not limited to, ATMs or other financial service kiosks, photo kiosks, internet kiosks, ticketing kiosks, directory/wayfinding kiosks, information kiosks, and the like.

In some embodiments, interactive kiosk 106 may include one or more sensors 120, one or more I/O interfaces 122, or other components. For example, sensors 120 may include one or more motion sensors, ambient noise sensors, microphones, proximity sensors, image sensors, gyroscopes, accelerometers, photoelectric sensors, infrared sensors, and the like. As another example, FO interfaces 122 may include input components (e.g., keypads, a mouse, card readers), NEC readers, retinal scanners, speakers, display screens (e.g., touch-screens), cameras, haptic output components, and the like.

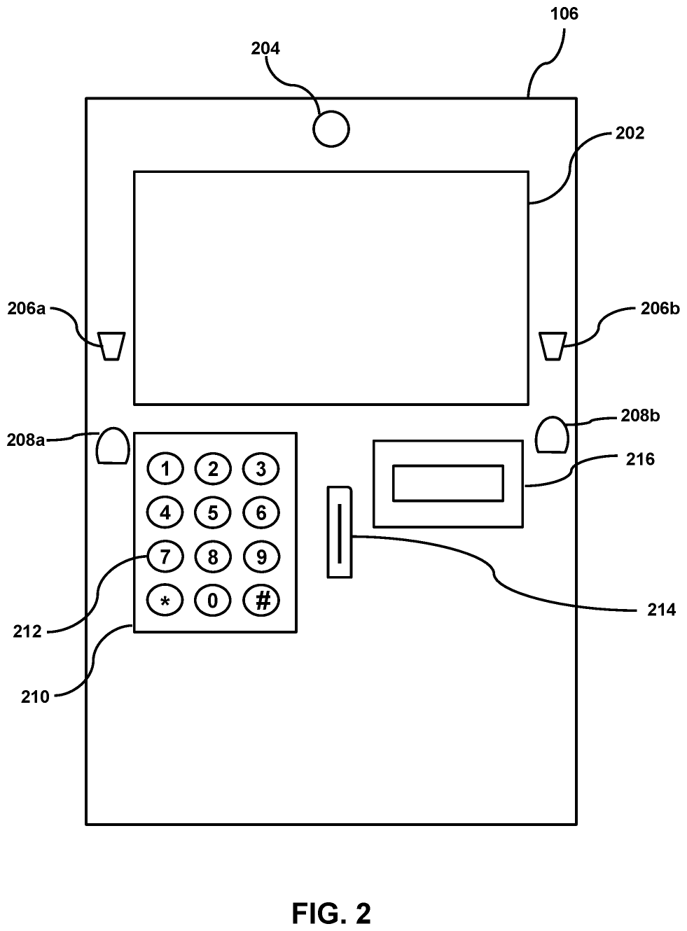

As an example, with reference to FIG. 2, interactive kiosk 106 is depicted including one or more instances of sensors 120 and 110 interfaces 122, as well as additional components. In some embodiments, interactive kiosk 106 may include a display screen 202. Some embodiments include display screen 202 corresponding to a touch-sensitive display screen. Information may be rendered by display screen 202, such as via a graphical user interface (GUI). In some embodiments, a user may interact with interactive kiosk 106 by touching a portion of display screen 202. For example, interactive kiosk 106 may allow a user to select an option (e.g., access a particular service) by pressing a GUI (e.g., a button) rendered by display screen 202.

In some embodiments, interactive kiosk 106 may include a camera 204 or other image-capturing component. Camera 204 may be configured to capture images, videos, or both, of an environment proximate to interactive kiosk 106. For example, camera 204 may capture a video of a room (e.g., an ATM vestibule) where interactive kiosk 106 is located. In some embodiments, camera 204 may be configured to continually capture images and/or videos of the environment of interactive kiosk 106. Alternatively, camera 204 may be configured to begin capturing images and/or video of the environment of interactive kiosk 106 in response to detecting the presence of a human within the environment. In some embodiments, one or more additional cameras may be communicatively coupled to camera 204 of interactive kiosk 106, and the additional cameras may be positioned at various locations about interactive kiosk 106. For example, an additional camera may be located within the environment of interactive kiosk 106, such as mounted to a wall within a room where interactive kiosk 106 is located. In such instances where additional cameras are included, each camera feed may be used independently or in combination to determine information regarding whether to provide access to a user.

Interactive kiosk 106 may include speakers 206a and 206b (collectively referred to as speakers 206), and microphones 208a and 208b (collectively referred to as microphones 208). Speakers 206 may be configured to output audio, while microphones 208 may be configured to detect sounds within an environment of interactive kiosk 106. In some embodiments, speakers 206 may be configured to output a single channel of sound (e.g., “mono”) or two channels of sound (e.g., “stereo”). Additional speakers may be communicatively coupled to interactive kiosk 106 such that surround sound may be output within the environment of interactive kiosk 106. Microphones 208 may be configured to detect sound waves output within the environment of interactive kiosk 106 and generate electrical signals representative of the detected sounds. Microphones 208 may be omnidirectional microphones, cardioid microphones, or any other type of microphone, or any combination thereof. In some embodiments, microphones 208 may be configured to determine a directionality and origination location of a source of the sound. Some embodiments may include additional microphones communicatively coupled to interactive kiosk 106, such as an additional microphone disposed in the environment of interactive kiosk. In some embodiments, microphones 208 may be configured to continuously capture sound detected within the environment of interactive kiosk 106, or may be configured to begin capturing sound upon detecting a human's presence within the environment or from another input mechanism.

In some embodiments, interactive kiosk 106 may include one or more input components, such as a keypad 210 and a card reader 214. Keypad 210 may include one or more physical or digital buttons 212, which may be interacted with by a user to provide information. For example, a user may input a personal identification number (PIN) by pressing or touching buttons 212 of keypad 210. In some embodiments, keypad 210 may include alphanumeric characters (e.g., letters, numbers, etc.) as well as symbols (e.g., “star,” “pound,” etc.). For example, buttons 212 may represent the letters of the English alphabet, the numbers 0-9, as well as additional symbols. Alternative languages, numbers, and symbols may also be included, depending on a location of interactive kiosk 106. Card reader 214 may be configured to receive a card, such as a credit card, and extract authentication credentials from the card to identify a user interacting with interactive kiosk 106. In some embodiments, card reader 214 may be configured to extract the authentication credentials from a magnetic strip of the card, from a chip integrated into the card, from electronic data stored by the card (e.g., a microprocessor and memory integrated on the card), or via other mechanisms, or a combination thereof. Furthermore, in some embodiments, interactive kiosk 106 may include an input/output component 216 configured to receive physical documents (e.g., checks, papers, cash etc.) as well as, or alternatively, output physical documents (e.g., cash, papers, etc.).

Subsystems 112-118

In some embodiments, message generation subsystem 112 may be configured to generate an audio message to be output by interactive kiosk 106. In some embodiments, message generation subsystem 112 may retrieve message data from message database 134 in response to determining that a user is within a predefined distance of interactive kiosk 106. For example, a proximity sensor, motion sensor, or other sensor, or combination of sensors, located on interactive kiosk 106 or communicatively coupled to interactive kiosk 106 (e.g., sensors 120) may detect when a human is present within an environment of interactive kiosk 106. In response to sensors 120 detecting human presence within the environment, interactive kiosk 106 may access message database 134 and obtain a message to be output by speakers 206.

In some embodiments, the messages may be stored as text data in message database 134. The text data may be provided to message generation subsystem 112, which may be configured to generate audio data representing the message. For instance, message generation subsystem 112 may include text-to-speech (TTS) functionality capable of converting input text data into output audio data. The audio data representing the audio message may then be output via speakers 206. In some embodiments, message database 134 may additionally, or alternatively, store audio data representing the audio message or messages to be output by speakers 206. Still further, audio data and/or text data representing a message to be output may be stored locally by computer system 102. In some embodiments, template text data or template audio data may be stored locally by computer system 102, and portions of the message may be retrieved from message database 134. As an example, template text data may include the text “Good {Temporal Word},” where {Temporal Word} is a placeholder for a word to be retrieved from message database 134 (e.g., {Temporal Word: “homing”}).

In some embodiments, message generation subsystem 112 may be configured to customize the message to be output to a user based on contextual information regarding the user, the location of interactive kiosk 106, temporal information related to a time that the user's presence was detected, and the like. In some embodiments, the contextual information may be determined by interactive kiosk 106, and may be provided to message database 134 for querying message database 134. For example, the contextual information may include metadata indicating a time that a request was sent from interactive kiosk 106 to message database 134, a GPS location extracted from an IP address of interactive kiosk 106 and/or computer system 102, and the like.

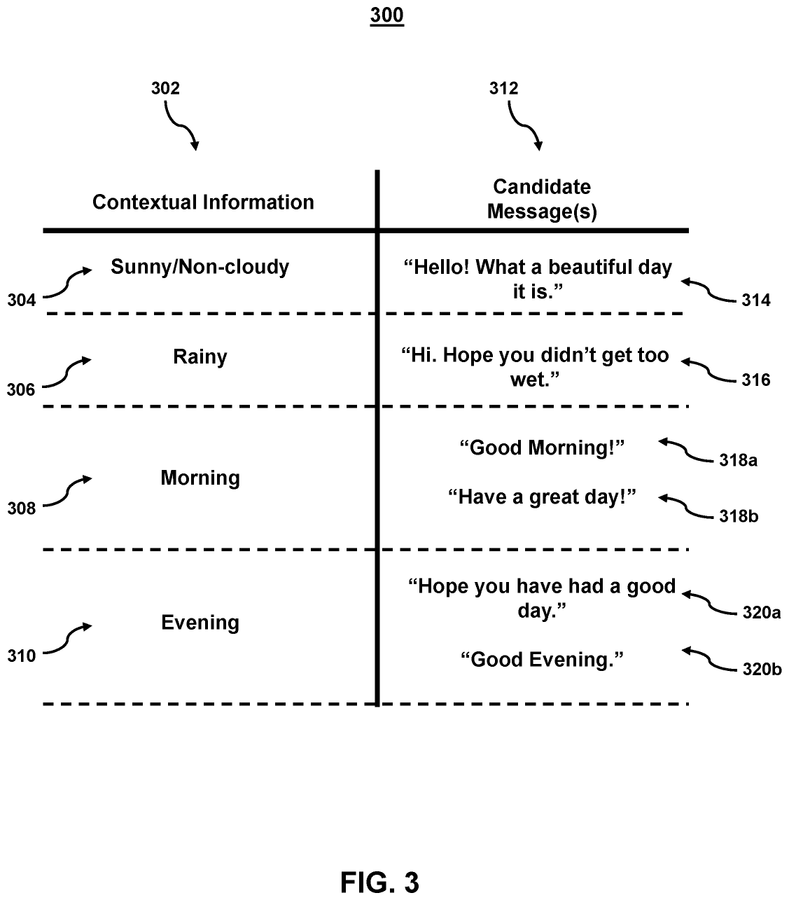

As an example, with reference to FIG. 3, table 300 includes a list of contextual information examples 302 and a list of related candidate messages 312 that may be selected and retrieved by message generation subsystem 112. As mentioned above, the particular candidate message may be selected by message generation subsystem 112 based on the contextual information that has been provided. List of contextual information examples 302 may include various examples of contextual information determined based on a location of interactive kiosk 106 and a time that a request for a message was sent by interactive kiosk 106 or computer system 102. In some embodiments, one or more third party services may be accessed to determine the appropriate contextual information to be used. For example, message generation subsystem 112 may be configured to access a weather service to determine a current weather, a predicted weather forecast, or weather-related information related to a geographic location of interactive kiosk 106. The geographic location may be determined based on a GPS location of interactive kiosk 106, an IP address of computer system 102 (implemented on or communicatively coupled to interactive kiosk 106), or other location-based information. Based on the geographic location, the weather service functionality may provide an indication to message generation subsystem 112 of a current or predicted weather, and message generation subsystem 112 may then use the current or predicted weather to identify a corresponding contextual information example from list of contextual information examples 302. For instance, list of contextual information examples 302 may include contextual information 304 and 306, corresponding to a first weather condition (e.g., sunny/non-cloudy weather) and a second weather condition (e.g., rainy weather). If the contextual information received from message generation subsystem 112 matches contextual information 304 or 306, then a corresponding message 314 or 316 from list of related candidate messages 312, respectively, may be selected and provided to message generation subsystem 112. For example, if the contextual information provided to message database 134 indicates that the current weather in the geographic location of interactive kiosk 106 is “sunny,” then message 314—“Hello! What a beautiful day it is.” may be retrieved by message generation subsystem 112, whereas if the current weather is “rainy,” then message 316—“Hi. Hope you didn't get too wet.”—may be retrieved by message generation subsystem 112.

In some embodiments, contextual information related to a current time at interactive kiosk 106 may be used to select a message from list of related candidate messages 312. For example, if the contextual information obtained by message generation subsystem 112 indicates that a current time is during morning hours—which may depend on the geographic location of interactive kiosk 106—this may match contextual information 308 from list of contextual information examples 302, whereas contextual information indicating that the current time is during the evening hours may match contextual information 310 from list of contextual information examples 302. Different candidate messages may be selected based on the matching contextual information. For example, if the current time at interactive kiosk 106 is determined as being during the morning hours (e.g., before 12:00 PM), then one of candidate message 318a—“Good morning!”—or candidate message 318b—“Have a great day!”—may be selected. Similarly, if the current time at interactive kiosk 106 is determined as being during evening hours (e.g., after 6:00 PM), one of candidate message 320a—“Hope you have had a good day.”—or candidate message 320b—“Good evening.”—may be selected.

In some embodiments, message generation subsystem 112 may be configured to generate a message to be output by speakers 206 based on actions of a user. For instance, if a user is approaching interactive kiosk 106, the message generated may be a greeting, whereas if the user has stopped interacting with interactive kiosk 106 and is leaving the environment of interactive kiosk 106, then the message may be a farewell message. Some embodiments may include message generation subsystem 112 determining whether a user is approaching or receding from interactive kiosk 106. This determination may be based on data obtained from sensors 120 and/or I/O interfaces 122, such as motion sensors or cameras communicatively coupled to interactive kiosk 106. For example, based on the data obtained from motion sensors of interactive kiosk 106, message generation subsystem 112 may determine that a user is approaching interactive kiosk 106 or has entered an environment where interactive kiosk 106 is located (e.g., an ATM vestibule). Therefore, the candidate message selected from list of related candidate messages 312 may be a greeting message, such as message 318a “Good morning!” or message 320a “Hope you have had a good day.” As another example, based on the data obtained from the motion sensors, message generation subsystem 112 may determine that a user is receding from interactive kiosk 106, indicating that the user is no longer interacting with interactive kiosk 106. Thus, the candidate message selected from list of related candidate messages 312 may be a farewell message, such as message 318b—“Have a great day!”

In some embodiments, response processing subsystem 114 may be configured to analyze a response provided by a user. For instance, the response may be a spoken utterance, a facial expression, a gesture, or other action, or combination thereof. In some embodiments, the response from the user may be based on a message provided to the user, such as an audio output by speakers 206. For example, in response to an audio message being output by speakers 206 when a user is determined to be within a predefined distance of interactive kiosk 106, the user may speak a reply, as well as exhibit a particular facial expression. While the audio message is being output, as well as after the audio message has been output, by speakers 206, camera 204 (as well as any additional cameras), microphones 208, and other sensors (e.g., sensors 120), may be configured to capture sounds and images/video of the user. For example, microphones 208 may begin capturing audio data of sounds emitted within the environment of interactive kiosk 106 while the audio message is being output. As another example, camera 204 may begin capturing video data representing video of the environment of interactive kiosk 106. In some embodiments, a position and direction of camera 204 (as well as any additional cameras) and microphones 208 may be modified so as to better capture video and audio, respectively, of the user. For instance, a perspective of camera 204 may be changed to be directed at the user's face.

Response processing subsystem 114 may include speech recognition functionality, facial recognition functionality, gesture recognition functionality, as well as additional or alternative functionalities for processing a captured response. In some embodiments, upon capturing a spoken reply utterance from a user, audio data representing the reply utterance may be transformed into text data using speech-to-text (STT) functionality. Response processing subsystem 114 including STT functionality may implement keyword spotting technology to evaluate audio signals in order to detect the presence of a predefined keyword or phrase, or other sound data, within the audio signal. In some embodiments, keyword spotting technology may output a true/false (e.g., logical I/O) signal indicating whether a particular word or phrase was uttered by the user. A score indicating a likelihood that the audio signal included the particular word or phrase may be produced and compared to a threshold value to determine whether that word or phrase can be declared as having been spoken. In some embodiments, response processing subsystem 114 may access one or more speech models stored by model database 140, which may be used to compare a sound or sequence of sounds (e.g., one or more phonemes) with the known sounds to identify matching words within the audio signals. The identified words may then be used to generate a text string representing a textual representation of the spoken utterance. In some embodiments, response processing subsystem 114 may implement STT functionality locally; however, one or more remote STT processing devices may be used in addition to, or instead of, local STT.

In some embodiments, response processing subsystem 114 may also include natural language processing (NLP) functionality, such as natural language understand (NLU) capabilities. NLU may operate in conjunction with STT functionalities to understand what a given utterance means and, if applicable, associate the utterance with an action or actions to be performed by a computing device (e.g., causing a light to turn on, causing a door to open, etc.). NLU aims to determine an intent of an utterance based on the spoken words and phrases. NLU may determine a category that the intent relates to, such as whether the utterance is directed to music, finance, sports, and the like, and based on the identified category and the text data generated from the audio data, resolve each spoken word or phrase to a known word or phrase. In this way, each portion of the spoken utterance may be attributed with a meaning understandable by computer system 102. In some embodiments, NLU may be customized for a given user, for a given demographic of users, and/or based on contextual features.

In some embodiments, response processing subsystem 114 may include facial recognition and facial expression recognition functionality. Facial recognition functionality includes determining an identity of an individual based on an image or images depicting that individual. Facial expression recognition functionality includes determining a facial expression exhibited by an individual based on an image or images of the individual.

Facial recognition functionality enables a computer system, such as computer system 102, to detect human faces within an image. In some embodiments, a given image may be transformed into a histogram of orientated gradients (HOG) image to determine whether the given image includes a human face pattern. Alternatively or additionally, facial landmark estimation may be used to determine whether a given image includes a human face pattern. Upon detecting that an image includes a human face, facial recognition functionality may attempt to determine whether the human face corresponds to a known human face. In some embodiments, a deep convolutional neural network (CNN) may be trained using a set of training images. The CNN may learn how to generate embeddings for each image representative of the faces included within the set of training images. For example, the embeddings may include a feature vector representing features extracted by the CNN of the image. Upon camera 204 capturing image data representing an image of a user within an environment of interactive kiosk 106, the CNN may extract features from the image data and compare the features to the known features from the training data set. A distance metric, such as a cosine distance, a Euclidean distance, or a Hamming distance, may be computed between the feature vector representing the features extracted from the image and the feature vectors associated with images from the training data set. The distance metric may indicate how similar the captured image is to an image from the training data set. In some embodiments, if the distance metric between the captured image and one of the images from the training data set satisfies a predefined threshold condition, such as the distance being less than or equal to a threshold value (e.g., less than or equal to 0.2, 0.1, 0.01, etc.), then the captured image may be classified as depicting a same human face as that of the image from the training data set.

Facial expression recognition corresponds to an ability to classify a face as depicting a particular emotion. Examples of the different types of emotions that a human face may express include, but are not limited to, anger, fear, happiness, sadness, surprise, confusion, or a neutral expression. In some embodiments, the facial expression recognition functionality may work in conjunction with the facial recognition functionality. For instance, to perform both facial expression recognition and facial recognition, a human face will need to be detected within an image and facial features will need to be extracted from the image. Therefore, some or all of the same features extracted during facial recognition processing may be used for facial expression recognition processing.

Similar to facial recognition, training data including a large number of images depicting human faces expressing different expressions may be obtained and used to train a CNN for recognizing facial expressions of human faces. In some embodiments, features may be extracted from the images to tune and train the weights and biases of the images. For example, the VGG-16 CNN may be used to extract features and output feature vectors of training images, such as images obtained from the ImageNet dataset. In some embodiments, a classifier (e.g., a classification model) may be trained to recognize particular facial expressions (e.g., anger, happiness, sadness, etc.). The output from the classifier may be vector including probabilities indicating a likelihood that a given image of a human face is depicting a particular expression. For example, if the categories include anger, fear, happiness, sadness, surprise, confusion, and neutral expressions, then the output vector may include seven probabilities, each in a range between 0 and 1.0 indicative of the likelihood that a human face depicted within an input image is expressing one of the aforementioned emotions.

In some embodiments, response processing subsystem 114 may also be configured to perform gesture recognition, which includes techniques for determining a gesture exhibited by a human within an image. Gesture recognition differs from facial expression recognition in that gesture recognition may include an analysis of more than just a human face, such as a face, torso, arms, legs, etc. Gesture recognition may also include determining a pose of the human depicted in an image. In some embodiments, gesture recognition functionality may employ a three-dimensional (3D) CNN for analyzing video captured by camera 204. The 3D CNN may extract features, similar to that described above with regards to facial recognition and facial expressions recognition. However, the 3D CNN may also, in some embodiments, extract spatial-temporal features (e.g., feature changes in space over time). In some embodiments, one or more recurrent neural networks (RNN), which may be obtained from model database 140, may be placed downstream from the 3D CNN to model temporal relationships between features, and a classifier, such as a Softmax function, to generate a vector including probabilities that a human depicted by a given video is performing a particular gesture. The various types of gestures that may be detected via the classifier include, but are not limited to, hand waves (a hand or hands moving right or left), other hand movements (e.g., thumbs up, thumbs down, etc.), arm movements, head movements, and the like.

Response processing subsystem 114 may receive the captured response from interactive kiosk 106 and may use one or more of the aforementioned processes (e.g., speech recognition functionality, NUT functionality, facial recognition functionality, facial expression recognition functionality, gesture recognition functionality, etc.), as well as other functionalities, to determine characteristics of a human's response to an audio message output from interactive kiosk 106. In some embodiments, response processing subsystem 114 may generate a combined feature vector based on the features extracted from some or all of the aforementioned recognition processes, which may be used to determine/identify a user in the environment of interactive kiosk 106.

In some embodiments, identification subsystem 116 may be configured to determine an identity of a user in an environment of interactive kiosk 106 based on a captured response to an output audio message. In some embodiments, identification subsystem 116 may obtain prior response data from user database 136, where the prior response data may include prior responses to previous audio messages. The prior responses may include responses to previous audio messages from one or more other users. For example, the prior responses may include facial expressions and spoken replies from users that responded to previous audio messages output by interactive kiosk 106. In some embodiments, the prior responses include responses from the user with whom the captured response corresponds.

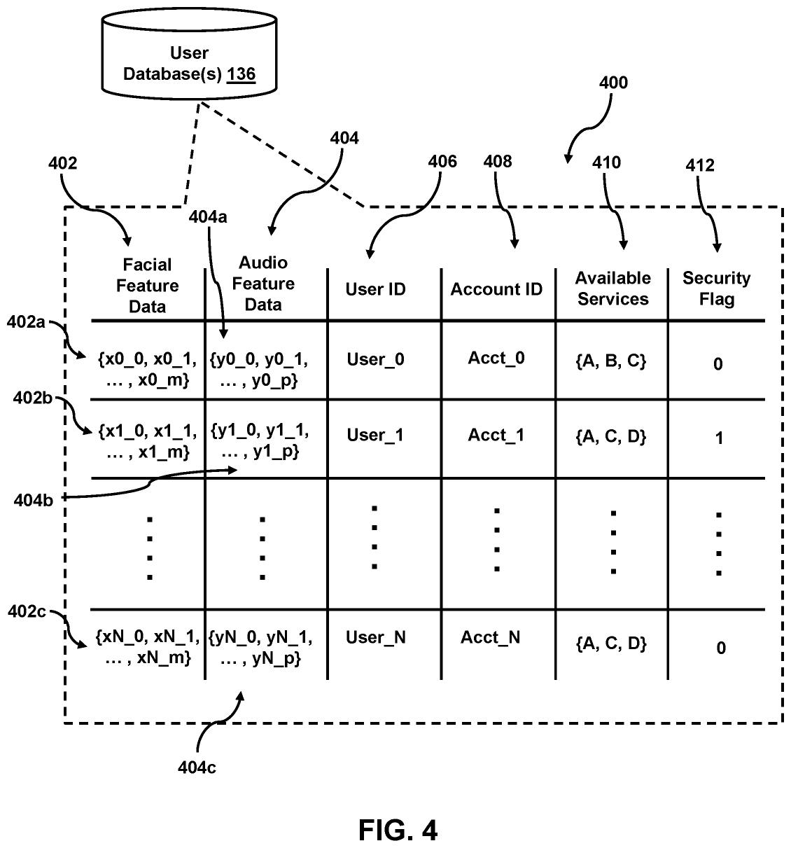

As an example, with reference to FIG. 4, table 400 stored by user database 136 includes prior response data and user account information for various users of system 100. For instance, table 400 may include facial feature data 402 and audio feature data 404. In some embodiments, feature data including facial feature data and audio feature data, as well as additional feature data, may be stored by user database 136. Each instance of feature data may be related to a different user. For example, facial feature data 402 may include N facial feature vectors, each associated with a different user that previously interacted with interactive kiosk 106, such as a first facial feature vector 402a including facial features related to a first user (e.g., User_0), a second facial feature vector 402b including facial features related to a second user (e.g., User_1), and a third facial feature vector 402c including facial features related to a third user (e.g., User_N). In some embodiments, each of facial feature vectors 402a-c may be an m-dimensional feature vector whose elements have been previously computed based on a facial recognition model, a facial expression recognition model, or other models, or a combination thereof. As another example, audio feature data 404 may include N audio feature vectors, each associated with a different user that previously interacted with interactive kiosk 106, such as a first audio feature vector 404a including audio features related to the first user (e.g., User_0), a second audio feature vector 404b including audio features related to the second user (e.g., User_1), and a third audio feature vector 404c including audio features related to a third user (e.g., User_N). In some embodiments, each of audio feature vectors 404a-c may be a p-dimensional feature vector whose elements have been previously, computed based on a speech recognition model, an audio fingerprint model, other models, or a combination thereof.

In some embodiments, identification subsystem 116 may be configured to determine a similarity between the captured response and the prior responses. For example, identification subsystem 116 may compute a distance metric between a feature vector representing features extracted from the captured response and feature vectors representing features of the prior responses. In some embodiments, the distance metric may include a cosine distance, a Euclidean distance, a Minkowski distance, or others. The distance metric may be computed between the a combined feature vector representing the combined features extracted from the captured response and combined feature vectors representing the combined features of the prior responses, or multiple distance metrics may be computed for each set of features extracted from a given image, series of images, video, audio, or other input data. For example, to determine whether a spoken reply captured by microphones 208 of interactive kiosk 106 matches another reply previously spoken by an authenticated user of system 100, an audio feature vector representing audio features extracted from audio data captured by microphones 208 may be compared to one or more of audio feature vectors 402a-c. Similarly, to determine whether a facial expression captured by camera 204 of interactive kiosk 106 matches a facial expression previously exhibited by an authenticated user of system 100, a facial feature vector representing facial features extracted from images and/or video captured by camera 204 may be compared to one or more of facial feature vectors 402a-c.

Identification subsystem 116 may obtain the N distance metrics, or αN distance metrics—where α is an integer greater than or equal to 1, and may be the distance metrics to determine whether the captured response matches a previous response of an authenticated user of system 100. For instance, as seen in table 4, each of facial feature vectors 402a-c and audio feature vectors 404a-c may be associated with a corresponding user identifier, User_0-N, respectively. For example, a previous response from User_0 to an output audio message from interactive kiosk 106 may have included a facial expression and a spoken reply. First facial feature vector 402a and audio feature vector 404a may have been generated and stored in association with an account of User_0, such as Acct_0 as indicated by Account ID listing 408. Upon a new response to an audio message being captured by interactive kiosk 106, identification subsystem 116 may compare a facial feature vector and an audio feature vector generated based on facial features, facial expression features, audio features, and/or other features, extracted from the newly captured response with first facial feature vector 402a and first audio feature vector 404a to compute a distance metric, or metrics, between the feature vectors. For example, a first distance metric computed based on the facial feature vector of the captured response and first facial feature vector 402a may yield a first distance D1, while a second distance metric computed based on the audio feature vector of the captured response and first audio feature vector 404a may yield a second distance D2. As another example, a single distance metric computed based on a feature vector representing features extracted from the captured response and a combined feature vector generated based on a combination of first facial feature vector 402a and first audio feature vector 404a may yield a distance D.

In some embodiments, a determination may be made as to whether the distance metric satisfies a similarity score threshold, which may also be referred to as a similarity condition. The distance metric, which indicates how similar a detected response is to one or more prior responses, may be compared with the similarity score threshold to determine whether the distance metric satisfies the similarity score threshold. The similarity score threshold may represent a value, such as a numerical value (e.g., 0.8, 0.9, etc.), that serves as a lower bound for determining whether two feature vectors can be classified as matching. If the computed distance metric is determined to be equal to or greater than the similarity score threshold, then this may indicate that the computed feature vector (e.g., the feature vector computed based on the captured response) and a feature vector associated with a prior response (e.g., first facial feature vector 402a, second facial feature vector 402b) match. If the computed distance metric is determined to satisfy the similarity score threshold, then this may indicate that the captured response was provided by the user associated with matching stored prior response. For example, if the captured response is determined to have a similarity score (e.g., a distance metric) that satisfies the similarity score threshold when compared to the response associated with first facial feature vector 402a and first audio feature vector 404a, then this may indicate that the user that provided the captured response is User_0, as indicated by User ID listing 406 of table 400.

In some embodiments, upon determining that the captured response matches a prior response of an authenticated user of system 100, identification subsystem 116 may be configured to determine an account associated with the matching authenticated user. For instance, as indicated within table 400, Account ID listing 408 may include account identifiers, which may each correspond to an account associated with a user from User ID listing 406. For example, if User_0 is determined as being the user ID of the user matched to the human that provided the captured response, then identification subsystem 116 may determine that User_0 is associated with Acct_0. Based on the account ID (e.g., Acct_0), one or more available services indicated by available services listing 410 associated with that account may be determined. For example, Acct_0 may have services A, B, and C available (e.g., cash withdrawals, check deposits, money transfers, etc.). Upon identifying the available services for the account ID of the matched user (e.g., User_0), computer system 102 may provide a notification to interactive kiosk 106 to indicate which services are available for the user to currently access. For example, if the user's account has cash withdrawals available as a service for his/her account, then interactive kiosk 106 may allow the user to perform cash withdrawals via interactive kiosk 106.

Different accounts may have different services available. For example, Acct_0 may have services A, B, and C available to a corresponding user (e.g., a user associated with user identifier: User_0), while Acct_1 may have services A, C, and D available to a corresponding user (e.g., a user associated with user identifier User_1). In some embodiments, a user may be requested to provide additional authentication information, such as additional authentication credentials, if a service is requested that is not available for that user's account. For example, if a captured response is determined to match a prior response associated with user identifier User_0, and the user that provided the captured response requests service D, then that user may be required to input additional authentication information to have access to the requested service. Some embodiments may include the user providing the additional authentication information via sensors 120, I/O interfaces 122, or other components, or a combination thereof. For instance, a user may input a credit card to card reader 214, input a PIN via keypad 210, verify contact information (e.g., a telephone number, mailing address, email, etc.) via client device 104, provide a biometric authentication (e.g., fingerprint, retinal scan, etc.), and the like.

In some embodiments, table 400 may include a security flag list 412, which stores an indicator representing whether a corresponding account has been flagged as being suspicious or having been associated with a suspicious behavior or behaviors. An account that has been flagged as being suspicious may have one or more of its available services (e.g., from available services listing 410) locked so as to prevent a user from accessing those services, require additional authentication credentials to be input by a user seeking to access services for that account, require verification from an authorized individual (e.g., an administrator of system 100), or any other means for verifying a user and his/her account, or any combination thereof. In some embodiments, the indicators stored by security flag list 412 may be binary values (e.g., logical 0/1). For example, the account associated with account identifier Acct_0 may have a security flag indicator 0, indicating that the account has not been flagged as being suspicious or having been associated with a suspicious behavior or behaviors. On the other hand, the account associated with account identifier Acct_1 may have a security flag indicator 1, indicating that this account has been flagged as being suspicious. Thus, a user attempting to access services of the account associated with account identifier Acct_1 may be required to provide additional authentication information in order to access one or more the available services (e.g., services A, C, D).

In some embodiments, model subsystem 118 may be configured to train and implement one or more prediction models to be used to authenticate a user attempting to access one or more services via an interactive kiosk or other input device, such as interactive kiosk 106. As mentioned above, identification subsystem 116 may employ one or more prediction models to analyze a captured response and determine whether the captured response satisfies a predefined authentication condition. For example, a determination may be made as to whether the captured response matches (e.g., is determined to have a similarity score satisfying a similarity threshold condition) a prior response associated with a particular user of system 100. The prediction models may be stored in model database 140 and retrieved by identification subsystem 116 when needed to identify a user associated with a captured response, as well as when the prediction models need to be trained. The data used to train each prediction model may be stored in training data database 138. In some embodiments, each user (e.g., user identifier stored in User ID listing 406) and/or account (e.g., account identifier stored in Account ID listing 408) may have training data generated specifically for that user. For example, a first user may have training data generated specifically for that user, which may be used to train a prediction model specifically for that user. As another example, a generalized prediction model may be trained based on training data including prior response data from a plurality of users of system 100, such as the users associated with user identifiers included within User ID listing 406. In some embodiments, multiple prediction models may be trained using different sets of training data generated for the type of output to be provided by that prediction model. For example, a prediction model configured to classify a spoken reply to an audio message output by interactive kiosk 106 may be trained using training data including audio data representing a plurality of previously spoken replies to previous audio messages.

In some embodiments, the prediction model may include one or more neural networks or other machine-learning models. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some embodiments, each individual neural unit may have a summation function which combines the values of all its inputs together. In some embodiments, each connection (or the neural unit itself) may have a threshold function such that the signal must surpass the threshold before it propagates to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free-flowing, with connections interacting in a more chaotic and complex fashion.

As an example, a machine-learning model may take inputs (e.g., data representing facial expressions of users in response to audio messages, data representing spoken replies from users in response to audio messages, data representing gestures performed by users in response to audio messages, etc.), and provide outputs (e.g., indications of a user identifier, user account identifier, etc.). In some embodiments, the outputs may be fed back to the machine-learning model as input to train the machine-learning model (e.g., alone or in conjunction with user indications of the accuracy of the outputs, labels associated with the inputs, or with other reference feedback information). In some embodiments, the machine-learning model may update its configurations (e.g., weights, biases, or other parameters) based on its assessment of its prediction (e.g., the outputs) and reference feedback information (e.g., user indication of accuracy, reference labels, or other information). In some embodiments, where the machine-learning model is a neural network (e.g., a convolutional neural network (CNN), a recurrent neural network (RNN), a transfer learning network, a depth separable convolutional neural network, etc.), connection weights may be adjusted to reconcile differences between the neural network's prediction and the reference feedback. Some embodiments include one or more neurons (or nodes) of the neural network requiring that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine-learning model may be trained to generate better predictions.

In some embodiments, training data may be collected for a user based on the user's response to an output audio message or messages prior to, during, or subsequent to, interacting with interactive kiosk 106. For example, upon determining that a user is within a predefined distance (e.g., 1-5 feet) of interactive kiosk 106, a first audio message may be output. A first response from the user, which may include a facial expression, a spoken reply, gesture performed, or other type of response, or a combination thereof exhibited by the user in connection with the outputting of the first audio message, may be captured by interactive kiosk 106 (e.g., via sensor(s) 120). Similarly, if access to one or more services have been provided to the user, a second audio message may be output upon determining that the user has stopped or is no longer interacting with interactive kiosk 106. In some embodiments, the second audio message may include a farewell message (e.g., “Have a good evening,” “See you later,” “Stay dry,” etc.). Alternatively, the second audio message may include a follow up message to determine whether the user seeks to continue interacting with interactive kiosk 106 (e.g., “Would you like to perform any other tasks,” “Can I assist you with anything else?”, “Have you finished?”, etc.). In some embodiments, training data for training a prediction model to recognize the user based on his/her response(s) to an audio message output by interactive kiosk 106 may be generated or updated based on the first response and the second response. For example, if training data for a particular user already exists (e.g., the user has already interacted with interactive kiosk 106 before), then the training data may be updated to include response data representing the first response and the second response. As another example, if training data for a particular user does not exist, training data may be generated to include response data representing the first response and the second response. Therefore, each interaction of a user with interactive kiosk 106 may serve to add to training data for training a prediction model associated with the user that may be used to recognize the user faster and more accurately during subsequent interactions of the user with interactive kiosk 106.

In some embodiments, initial training data for training a prediction model for a user may be generated by requesting that the user respond to audio messages output by interactive kiosk 106, client device 104, or both. For example, an individual may participate in a training session with interactive kiosk 106 whereby a set of audio messages may be output by interactive kiosk 106 and the individual's responses to those audio messages may be captured. As another example, an individual may participate in a training session using a software application executing on client device 104, where the software application causes a set of audio messages to be output by client device 104 and the individual's responses to the audio messages may be captured by one or more sensors resident on or communicatively coupled to client device 104.

Example Flowcharts

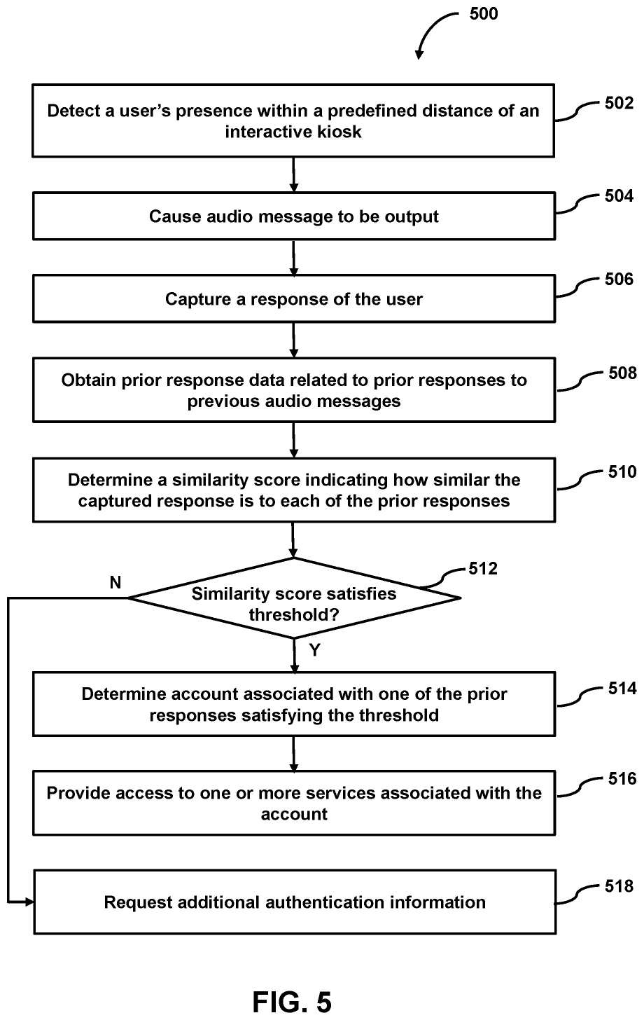

FIGS. 5-7 are example flowcharts of processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

FIG. 5 shows a flowchart of a method 500 of determining whether to provide access to secure services via an interactive kiosk, in accordance with one or more embodiments. In an operation 502, a user's presence may be detected within a predefined distance of an interactive kiosk. For example, a determination may be made as to whether a human (e.g., the user) is within a predefined distance (e.g., less than 1 foot, less than 5 feet, less than 10 feet, etc.) of interactive kiosk 106. In some embodiments, interactive kiosk 106 may include sensors 120, such as one or more motion sensors, proximity sensors, or other sensors, capable of detecting motion within an environment of interactive kiosk 106. Upon detecting the motion, one or more processors communicatively coupled to sensors 120 (e.g., resident on interactive kiosk 106) may determine, based on the detected motion signals, a distance between the human and interactive kiosk 106. Upon determining that the distance satisfies a distance threshold condition, such as being less than or equal to a threshold distance (e.g., less than 1 foot, less than 5 feet, less than 10 feet, etc.), the processors may be configured to classify the human as being within the predefined distance of interactive kiosk 106. Alternatively or additionally, interactive kiosk 106 may include a signal strength sensor, such as a received signal strength indicator (RSSI) sensor, a Bluetooth signal detection sensor, or other signal strength sensor, configured to detect the presence of an electrical signal being output by client device 104. For instance, upon entering an environment of interactive kiosk 106 (e.g., an ATM vestibule), an RSSI sensor of interactive kiosk 106 may detect an output power level (e.g., RSSI level) emitted from a communications component of client device 104. If the output power level satisfies a signal strength threshold (e.g., −40 to −60 dB-microvolts/meter), then the client device may be classified as being within a predefined distance of interactive kiosk 106. In some embodiments, operation 502 may be performed by a subsystem that is the same as or similar to message generation subsystem 112.

In an operation 504, an audio message may be caused to be output. The audio message may be output via speakers 206 of interactive kiosk 106; however, additional audio output components may be used in addition to or instead of speakers 206. In some embodiments, the audio message to be output may be selected based on contextual information associated with interactive kiosk 106. The contextual information may include location information, temporal information, or other information, or a combination thereof, related to interactive kiosk 106. In some embodiments, location information indicating a location of interactive kiosk 106 may be used to retrieve weather forecasting information, traffic information; sporting news; current events, and the like from various third party data sources. The retrieved information may then serve as an additional input when a message is selected from message database 134 to be output. For example, based on the location information related to a location of interactive kiosk 106, weather information for the location may be retrieved from a weather service. The weather information may then be used, alone or in conjunction with other contextual information, to query and select one of the candidate messages from list of related candidate messages 312. For instance, if the weather information indicates that the current weather for the location of interactive kiosk 106 is “sunny,” then message 314 may be selected for use as the audio message to be output from interactive kiosk 106. As mentioned above, some embodiments may include the selected message being audio data, such that the audio message may be output upon receipt from message database 134. Alternatively, the selected message may be stored by message database 134 as text data, and TTS functionality of computer system 102 may be used to generate audio data representing the text data, which in turn may be output by interactive kiosk 106. In some embodiments, operation 504 may be performed by a subsystem that is the same as or similar to message generation subsystem 112.

In an operation 506, a response of the user may be captured. In some embodiments, the captured response may include a spoken reply from the user to the audio message, a facial expression exhibited by the user to the audio message, or other types of responses from the user in connection with the outputting of the audio message. The response from the user may be captured via one or more image capturing components, such as camera 204, one or more audio input devices, such as microphones 208, as well as additional sensors. In some embodiments, as the audio message begins to output from speakers 206, microphones 208 and camera 204 (as well as additional sensors) may begin capturing data. Some embodiments may include transforming, editing, or performing other processing, or a combination thereof, to some or all of the captured response. For example, audio data representing the spoken reply may be converted to text data using STT functionality. As another example, features may be extracted from captured video of the user, and a feature vector representing the extracted features may be generated based on a facial expression recognition model (e.g., one or more CNNs, RNNs, etc.) stored by model database 140. In some embodiments, operation 506 may be performed by a subsystem that is the same as or similar to response processing subsystem 114.

In an operation 508, prior response data related to prior responses to previous audio messages may be obtained. The prior response data may include facial expressions of one or more other users, spoken replies from the other users, or other types of responses from the other users, or a combination thereof, to previous audio messages. In some embodiments, the prior response data may be obtained in response to the audio message being output, the response being captured, or the user's presence being detected within the predefined distance of interactive kiosk 106. Some embodiments may include obtaining prior response data that has been captured within a predetermined amount of time of the audio message being output, the response being captured, or the user's presence being detected within the predefined distance of interactive kiosk 106. For example, a most recent set of prior responses may include responses provided within a last week, month, year, etc. In some embodiments, operation 508 may be performed by a subsystem that is the same as or similar to response processing subsystem 114.

In an operation 510, a similarity score indicating how similar the captured response is to each of the prior responses may be determined. In some embodiments, the similarity score may be computed by comparing a feature vector or feature vectors representing the captured response to a feature vector or feature vectors for each of the prior responses. For example, the captured response may include a facial expression exhibited by the user and a spoken reply from the user in connection with the outputting of the audio message. In some embodiments, a feature vector representing the features extracted from video capturing the facial expression may be generated, a feature vector representing features extracted from audio signals capturing sounds emitted by the user or within the environment of interactive kiosk 106 may be generated, and/or additional feature vectors may be generated. The feature vector associated with facial expressions may be compared to feature vectors associated with facial expressions of prior responses to determine a similarity score indicating whether the facial expression of the user is the same as or similar to a facial expression previously exhibited by another user in connection with a prior audio message. Similarly, the feature vector associated with the captured spoken reply may be compared to feature vectors associated with previous replies to the audio message to determine whether the spoken reply is the same as or similar to a spoken reply previously uttered by another user in connection with a prior audio message. Some embodiments may include computing a distance metric, such as a cosine distance, a Euclidean distance, a Minkowski distance, and the like, in order to obtain the similarity score. Thus, a plurality of similarity scores, at least one for each prior response, may be generated and used to determine whether the captured reply is similar to a previous response from another user. In some embodiments, a single feature vector representing features extracted from images, video, audio, or other input channels, may be generated instead of multiple feature vectors, and the single feature vector may be compared to a single feature vector for the other prior responses to determine a similarity score with respect to a given prior response's feature vector. The similarity score may indicate a degree of similarity (e.g., how similar) a feature vector is to another feature vector. As described herein, a degree of similarity may refer to a measure for how similarity two entities (e.g., vectors existing in a vector space) are to one another. In some embodiments, operation 510 may be performed by a subsystem that is the same as or similar to identification subsystem 116.

In an operation 512, a determination may be made as to whether the similarity score satisfies a similarity score threshold. The similarity score threshold may include a distance threshold. For example, if a cosine distance is used to compute how similar two feature vectors are, then the distance threshold may be set at 0.8 or greater, 0.9 or greater, 0.95 or greater, etc. Thus, the two feature vectors may be classified as being similar or the same if the cosine distance metric produces a result equal to or exceeding the distance threshold. In some embodiments, the similar score may be determine based on a combination of similarity scores for each channel (e.g., facial expression, spoken reply, etc.) with which a feature vector is generated from the captured response and compared with a corresponding feature vector of a prior response from another user. For example, a first distance metric computing a similarity between a user's facial expression in response to the output audio message and another user's facial expression in response to a previous audio message may be combined with a second distance metric computing a similarity between the user's spoken reply to the audio message and the other user's reply to the previous audio message. The first distance metric and the second distance metric may be the same metric (e.g., both cosine distances) or different metrics (e.g., one cosine distance, one Minkowski distance). Depending on the particular similarity metric used to compute similarity, indicating a degree (e.g., how similar) of similarity, the mechanisms for combining the metrics may vary (e.g., linear combination, least square fit combination, extrapolation via a fit function, etc.). In some embodiments, if a single feature vector is used—for instance by combining the multiple input channels from the response then a single threshold distance may be used to determine whether the single feature vector is to be classified as being the same as or similar to another feature vector associated with a prior response from another user. In some embodiments, operation 512 may be performed by a subsystem that is the same as or similar to identification subsystem 116.

If, at operation 512, it is determined that the similarity score between the captured response and one of the prior responses satisfies the similarity score threshold, then method 500 may proceed to operation 514. For example, it may be determined that the similarity metric measuring a degree of similarity between the captured response and one of the prior responses satisfies a predefined authentication condition used to authorize access to one or more services available (e.g., from interactive kiosk 106). At operation 514, an account associated with the one the prior responses may be determined. In some embodiments, the similarity score may be determined to satisfy the similarity score threshold based on a distance metric computed between the captured response and a prior response. For example, a feature vector associated with facial features exhibited by the user when the audio message was output may be compared to first facial feature vector 402a including facial features related to a first user (e.g., User_0). If the distance metric between the feature vector and first facial feature vector 402a satisfies a distance threshold, then this may indicate that the facial expression exhibited by the user matched one of the previously captured facial expressions of User_0 when User_0 provided a response to a previous audio message. Thus, this may indicate that the captured response was provided by the user associated with user ID User_0. User_0 may be associated with an account of system 100 having account ID Acct_0. Thus, Acct_0 may be determined as the account of the user that provided the captured response. In some embodiments, operation 514 may be performed by a subsystem that is the same as or similar to identification subsystem 116.

In an operation 516, access to one or more services associated with the determined account may be provided to the user. In some embodiments, the one or more services may include services determined to be available/accessible for to the user associated with the account. For example, the account associated with account ID Acct_0 may have services A, B, and C available to the corresponding user. These services may then be available for the user to access via interactive kiosk 106. Some embodiments may include two or more similarity scores, corresponding to two or more prior responses, satisfying a predefined authentication condition, such as a similarity score threshold. In some embodiments, a top-ranked similarity score of the two or more similarity scores satisfying the similarity score threshold may be used to determine the account with which the corresponding captured response is associated. Alternatively, or additionally, some embodiments may include requesting additional authentication information, such as additional account credentials (e.g., a PIN, a biometric input, a security question, etc.) be input to disambiguate between the possible accounts that may be matched to the captured response. In some embodiments, operation 516 may be performed by a subsystem that is the same as or similar to identification subsystem 116.

If, at operation 512, it is determined that no similarity scores satisfy the similarity score threshold, then method 500 may proceed to operation 518. For example, this may indicate that the captured response and each of the prior responses do not satisfy the predefined authentication condition. In operation 518, additional authentication information may be requested. For instance, if the captured response is unable to be linked to any prior responses, then the captured response may be unassociated with any of the accounts of system 100. However, the user may, in fact, be associated with an account of system 100, although the captured response may differ from any of the prior responses previously provided by that user. In some cases, the user may be requested to provide additional authentication information in order to identify the account of that user. For example, interactive kiosk 106 may request that a user insert or swipe a credit card via card reader 214, input a PIN using keypad 210 or display screen 202, provide a response to a security question or questions, or provide any other type of additional authentication information to identify the user, or any combination thereof. In some embodiments, operation 518 may be performed by a subsystem that is the same as or similar to identification subsystem 116.

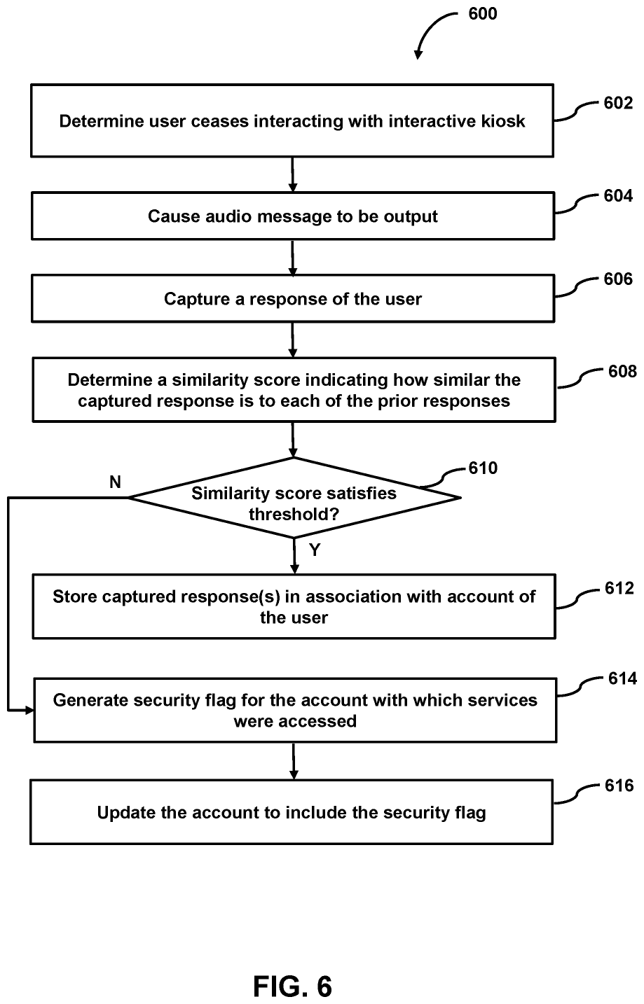

FIG. 6 shows a flowchart of another method 600 of determining whether to flag an account based on a captured response to an audio message, in accordance with one or more embodiments. Method 600 may begin at operation 602. In operation 602, a determination may be made that a user ceases interacting with an interactive kiosk. In some embodiments, interactive kiosk 106, computer system 102, or both, may be configured to monitor the user's interactions with interactive kiosk 106 after access to the available services has been provided. Such interactions may include, but are not limited to, speaking additional utterances to interactive kiosk 106, requesting information or items from interactive kiosk 106 (e.g., requesting a cash withdrawal, requesting a financial statement, requesting a copy of a ticket, etc.), providing information or items to interactive kiosk 106 (e.g., inputting a credit card or other item storing account credentials, providing cash or checks via input/output component 216, etc.), or other interactions, or a combination thereof. In some embodiments, determining that the user has stopped interacting with interactive kiosk 106 may include determining that no inputs have been provided to interactive kiosk 106 (e.g., via display screen 202, keypad 210, microphones 208, etc.) for a predefined amount of time (e.g., 30 seconds, 1 minute, 2 minutes, etc.). In some embodiments, determining that the user has stopped interacting with interactive kiosk 106 may include determining, via sensors 120, that the user has moved away from interactive kiosk 106, turned his/her body to no longer be facing interactive kiosk 106, spoken an utterance indicative of a session with interactive kiosk 106 ending (e.g., “Bye”), and the like. In some embodiments, operation 602 may be performed by a subsystem that is the same as or similar to message generation subsystem 112.

In an operation 604, an audio message may be caused to be output from interactive kiosk 106. In some embodiments, the audio message may be output in response to determining that the user has ceased interacting with interactive kiosk 106. For example, in response to determining that the user is no longer interacting with interactive kiosk 106, one of the candidate messages from list of related candidate messages 312 may be selected, and audio data representing the selected message may be output via speakers 206. In some embodiments, contextual information related to interactive kiosk 106 may be used to determine which candidate message from list of related candidate messages 312 to select. For instance, contextual information related to a local weather forecast of the geographic area where interactive kiosk 106 is located may be obtained and serve as a basis for the selection of the candidate message. In some embodiments, the contextual information may be the same as or similar to the contextual information used to select the message output by interactive kiosk 106 upon detecting the user's presence within an environment of interactive kiosk 106. For example, the contextual information used to select a message, as described above with respect to operation 504 of FIG. 5, may also be used to select the message associated with operation 604 of FIG. 6. As another example, new or updated contextual information may be obtained and the audio message to be output at operation 604 may be selected based on the new or updated contextual information. In some embodiments, upon selecting a candidate message from list of related candidate messages 312 (e.g., audio message 318b—“Have a great day!”), audio data representing the selected candidate message may be obtained from message database 134 and output by speakers 206 of interactive kiosk 106. As mentioned above with reference to operation 504 of FIG. 5, list of related candidate messages 312 may be stored in message database 134 as text data, audio data, or both. If the selected message is stored as text data, TTS functionality of computer system 102 may be used to generate audio data representing the message. In some embodiments, operation 604 may be performed by a subsystem that is the same as or similar to message generation subsystem 112.

In an operation 606, a response of the user may be captured in connection with the outputting of the audio message. For instance, in response to determining that the user ceased interacting with interactive kiosk 106 or the audio message being output, camera 204, microphones 208, or other sensor, or a combination thereof, may begin capturing a response from the user. In some embodiments, the response may include a facial expression exhibited by the user, a spoken reply to the message, gestures performed by the user, or other types of responses, or a combination thereof, prior to, during, or after the audio message (e.g., the audio message of operation 604) has been output. Some embodiments include capturing sounds detected by microphones 208 within the environment of interactive kiosk 106 in connection with the outputting of the audio message. A determination may then be made as to whether a reply was uttered by the user. For instance, in response to the audio message “Goodbye,” a user may not speak at all. In some embodiments, operation 606 may be performed by a subsystem that is the same as or similar to response processing subsystem 114.

In an operation 608, a similarity score indicating how similar the captured response is to each of the prior responses may be deter mined. For instance, a similarity metric indicating a degree of similarity between two (or more) responses may be determined. In some embodiments, operation 608 may be substantially similar to operation 508 of FIG. 5, with the exception that the audio message, and the captured response in connection with audio message, may be selected and output in response to determining that a user has ceased interacting with interactive kiosk 106. Therefore, the similarity between the captured response and the prior responses may include a determination of how similar (e.g., a degree of similarity) the captured response is to other previously captured responses when a user ceases interacting with interactive kiosk 106. In some embodiments, because a user account may have already been determined prior to the user interacting with interactive kiosk 106, the similarity determined at operation 608 may be restricted to comparing the captured response to other responses previously captured by the user associated with that user account. However, some embodiments may include determining a similarity score between the captured response and other users' previously captured responses. In some embodiments, operation 608 may be performed by a subsystem that is the same as or similar to identification subsystem 116.

In an operation 610, a determination may be made as to whether the similarity score satisfies a similarity score threshold. In some embodiments, the similarity score threshold of operation 610 may be the same as the similarity score threshold of operation 510 of FIG. 5; however, alternatively the similarity score threshold of operation 610 may differ from that of operation 510. In some embodiments, the similarity score threshold of operation 610 may be greater than that of operation 510 because the account of the user may be known. For example, if the similarity score threshold at operation 510 is a distance metric, such as a cosine similarity, the distance threshold may be 0.8, whereas at operation 610 the distance threshold may be 0.9. In some embodiments, operation 610 may be performed by a subsystem that is the same as or similar to identification subsystem 116.

If, at operation 610, it is determined that the similarity score satisfies the similarity score threshold, then method 600 may proceed to operation 612. In operation 612, the captured response (e.g., the response captured at operation 606) may be stored in association with the account of the user. For example, if the user account associated with the user that had previously been interacting with interactive kiosk 106 corresponded to account identifier Acct_0, then the captured response to the audio message (e.g., a farewell message from operation 606) may be stored in association with the account of account identifier Acct_0. In some embodiments, any additional responses captured by interactive kiosk 106, client device 104, or other sensors, or a combination thereof, in connection with a user session with interactive kiosk 106 may also be stored in association with the user account. For example, the response captured in connection with the audio message (e.g., a greeting message) when the user was determined to be within a predefined distance of interactive kiosk 106 may also be stored in association with the user account. Furthermore, any facial expressions, utterances, gestures, or other types of responses, from the user when interacting with interactive kiosk 106 during the user session may also be captured and stored in association with the user account. In some embodiments, operation 612 may be performed by a subsystem that is the same as or similar to identification subsystem 116, model subsystem 118, or both identification subsystem 116 and model subsystem 118.

If at operation 610 it was determined that none of the determined similarity scores satisfied the similarity score threshold, then method 600 may proceed to operation 614. In operation 614, a security flag for the account with which services were accessed may be generated. For instance, initially it may have been determined, based on the captured response to a greeting audio message (e.g., operations 504 and 506), that the user determined to be within the environment of interactive kiosk 106 was associated with a user account corresponding to account identifier Acct_0. However, based on the captured response to a farewell message (e.g., operations 604 and 606), it may be determined that the user may not actually be the user associated with account identifier Acct_0. In some embodiments, the discrepancy between the user account determined during the initial interaction with interactive kiosk 106 and the user account determined during the final interaction with interactive kiosk 106 may indicate that a suspicious activity and/or behavior has occurred that requires further investigation. For example, the user may be under duress and therefore his/her responses to the farewell message may differ from the expected responses to a farewell message that he/she previously exhibited. As an illustration, if the user typically provides a spoken reply to a farewell message, but in the current instance, the user says nothing, this may indicate an abnormal behavior and may require additional investigation. In some embodiments, the security flag may cause certain services typically available to a user to be suspended, additional authentication information be provided, or further analysis by an administrator (e.g., by reviewing a video of the response). In some embodiments, operation 614 may be performed by a subsystem that is the same as or similar to identification subsystem 116.

In an operation 616, the account of the user may be updated to include the security flag. For example, security flag list 412 may be updated such that the generated security flag is stored in associated with the user account. In some embodiments, the generated security flag may replace the security flag currently stored in association with the user account. In some embodiments, operation 616 may be performed by a subsystem that is the same as or similar to identification sub system 116.

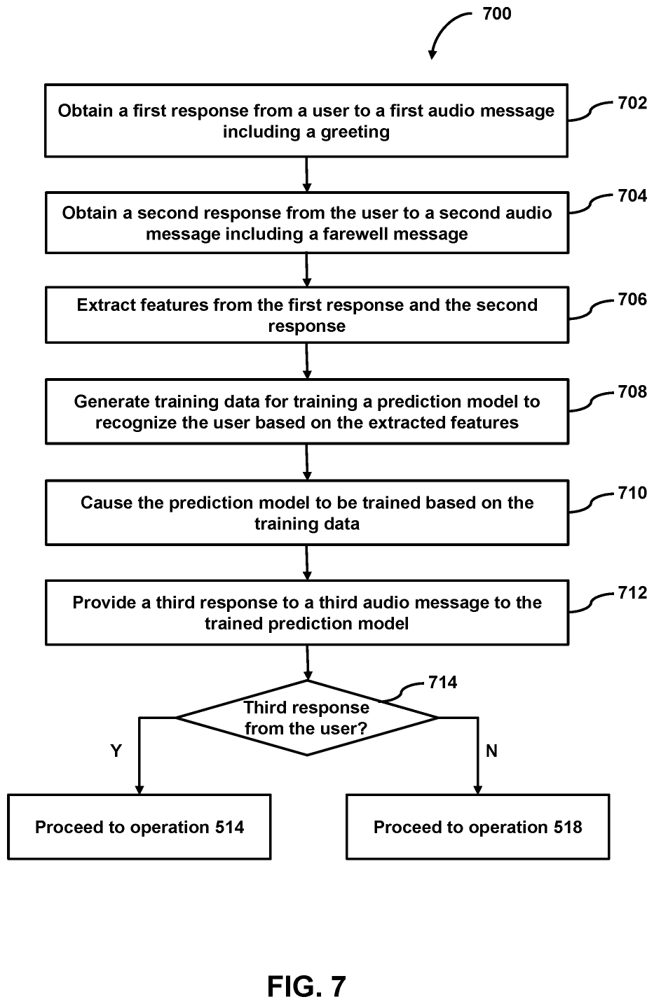

FIG. 7 shows a flowchart of yet another method 700 for generating training data for a prediction model to be used for determining whether to provide access to secure services via an interactive kiosk, in accordance with one or more embodiments. In some embodiments, method 700 may begin at an operation 702. In operation 702, a first response from a user to a first audio message including a greeting message may be obtained. In some embodiments, the first response may include a facial expression exhibited by the user in connection with the outputting of the greeting message, a spoken reply uttered by the user in connection with the outputting of the greeting message, a gesture or gestures perform filed by the user in connection with the outputting of the greeting message, and the like. In some embodiments, operation 702 may be similar to operation 506 of FIG. 5, and the previous description may apply. In some embodiments, operation 702 may be performed by a subsystem that is the same as or similar to response processing subsystem 114.

In an operation 704, a second response from the user to a second audio message including a farewell message may be obtained. In some embodiments, the second response may include a facial expression exhibited by the user in connection with the outputting of the farewell message, a spoken reply uttered by the user in connection with the outputting of the farewell message, a gesture or gestures performed by the user in connection with the outputting of the farewell message, and the like. In some embodiments, operation 704 may be similar to operation 606 of FIG. 6, and the previous description may apply. In some embodiments, operation 704 may be performed by a subsystem that is the same as or similar to response processing subsystem 114.

In an operation 706, features may be extracted from the first response and the second response. In some embodiments, features may be extracted using one or more models stored by, model database 140. For example, a facial expression recognition model may be retrieved from model database 140 to extract facial expression features from an image, set of image, video, etc., of the first response and the second response. As another example, an audio fingerprint model may be retrieved from model database 140 to extract audio fingerprints from the sounds captured by the response. Additional features may also be extracted using different models depending on the input channels and the types of models available. In some embodiments, a feature vector may be generated representing the extracted features from the response. The feature vector may be an n-dimensional vector mapping the response to a point in a feature space. Each response, therefore, may map to a point in the feature space. As more and more data is collected for a given user, clusters may form in the feature space for a user. The clusters may initially be sparse and spread out; however, as more data is collected, the clusters may become denser. This may make it easier to determine an identity of a user based on a captured response, as the distance between a new feature vector representing features extracted from a captured response should have a smaller distance from a center of the user's cluster as opposed to a different user's cluster. In some embodiments, operation 706 may be performed by a subsystem that is the same as or similar to model subsystem 118.

In an operation 708, training data for training a prediction model to recognize the user based on the extracted features may be generated. In some embodiments, the training data may include the extracted features, the generated feature vectors, or both, from the first response and the second response. In some embodiments, the training data may be generated after each user session with interactive kiosk 106, or periodically, such as weekly, monthly, etc. Alternatively or additionally, the training data may be generated subsequent to a predefined number of responses being captured (e.g., two or more responses being captured, ten or more responses being captured, 20 or more responses being captured, etc.). The training data may be stored in training data database 138. In some embodiments, the training data may be stored with an indication of the user ID, account ID, or other identifier of the user that the training data was generated for. Additionally or alternatively, the training data may be stored in training data database 138 with temporal information indicating a time that the training data was generated, an identifier associated with the device that was used to capture the responses used to generate the training data (e.g., client device 104, interactive kiosk 106, etc.), and the like. In some embodiments, operation 708 may be performed by a subsystem that is the same as or similar to model subsystem 118.

In an operation 710, the prediction model may be caused to be trained based on the training data. In some embodiments, the training data may be provided to the prediction model, which may perform training using the training data. In some embodiments, a prediction model may be trained specifically for a given user based on that user's training data (e.g., the training data generated based on the first and second responses from the user). However, the prediction model may also be trained based on other users' training data. The more training data used, the greater the prediction model's ability will be to identify a particular user based on a future response to a future audio message. In some embodiments, operation 710 may be performed by a subsystem that is the same as or similar to model subsystem 118.

In an operation 712, a third response to a third audio message may be provided to the trained prediction model. In some embodiments, the third response may be captured by interactive kiosk 106 in response to an audio message being output. For example, in response to a user being detected within a predefined distance of interactive kiosk 106, an audio message (e.g., a greeting message) may be output from speakers 206. Camera 204, microphones 208, other sensors, or a combination thereof, may capture the response of the user in connection with the outputting of the audio message. The captured response may then be provided to the trained prediction model as an input, and the trained prediction model may attempt to determine a user that provided the third response. In some embodiments, operation 712 may be performed by a subsystem that is the same as or similar to message generation subsystem 112, response processing subsystem 114, model subsystem 118, or a combination thereof.

In an operation 714, a determination may be made as to whether the third response was from the same user that provided the first response and the second response. In some embodiments, the trained prediction model may classify the third response as being from the user, from a different user, or not being able to classify the third response to any other user. If, at operation 714, it is determined that the third response was from the user, then method 700 may proceed to operation 514 of FIG. 5. Alternatively, if the third response was determined to not be from the user, then method 700 may proceed to operation 518 of FIG. 5. In some embodiments, operation 714 may be performed by a subsystem that is the same as or similar to identification subsystem 116, model subsystem 118, or a combination thereof.

In some embodiments, the various computers and subsystems illustrated in FIG. 1 may include one or more computing devices that are programmed to perform the functions described herein. The computing devices may include one or more electronic storages (e.g., prediction database(s) 132, which may include message database(s) 134, user database(s) 136, training data database(s) 138, model database 140, etc., or other electronic storages), one or more physical processors programmed with one or more computer program instructions, and/or other components. The computing devices may include communication lines or ports to enable the exchange of information with one or more networks 150 (e.g., the Internet, an intranet, etc.) or other computing platforms via wired or wireless techniques (e.g., Ethernet, fiber optics, coaxial cable, Wi-Fi, Bluetooth, near field communication, or other technologies). The computing devices may include a plurality of hardware, software, and/or firmware components operating together. For example, the computing devices may be implemented by a cloud of computing platforms operating together as the computing devices.

The electronic storages may include non-transitory storage media that electronically stores information. The storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-118 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-118 described herein is for illustrative purposes, and is not intended to be limiting, as any of subsystems 112-118 may provide more or less functionality than is described. For example, one or more of subsystems 112-118 may be eliminated, and some or all of its functionality may be provided by other ones of subsystems 112-118. As another example, additional subsystems may be programmed to perform some, or all of the functionality attributed herein to one of subsystems 112-118.

Although the present application has been described in detail for the purpose of illustration based on what is currently considered to be the most practical and preferred embodiments, it is to be understood that such detail is solely for that purpose and that the present application is not limited to the disclosed embodiments, but, on the contrary, is intended to cover modifications and equivalent arrangements that are within the scope of the appended claims. For example, it is to be understood that the present application contemplates that, to the extent possible, one or more features of any embodiment can be combined with one or more features of any other embodiment.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the context clearly indicates otherwise. Thus, for example, reference to “an element” or “a element” includes a combination of two or more elements, notwithstanding use of other terms and phrases for one or more elements, such as “one or more.” The term “or” is non-exclusive (i.e., encompassing both “and” and “or”), unless the context clearly indicates otherwise. Terms describing conditional relationships, (e.g., “in response to X, Y,” “upon X, Y,” “if X, Y,” “when X, Y,”) and the like, encompass causal relationships in which the antecedent is a necessary causal condition, the antecedent is a sufficient causal condition, or the antecedent is a contributory causal condition of the consequent, (e.g., “state X occurs upon condition Y obtaining” is generic to “X occurs solely upon Y” and “X occurs upon Y and Z.”). Such conditional relationships are not limited to consequences that instantly follow the antecedent obtaining, as some consequences may be delayed, and in conditional statements, antecedents are connected to their consequents, (e.g., the antecedent is relevant to the likelihood of the consequent occurring). Statements in which a plurality of attributes or functions are mapped to a plurality of objects (e.g., one or more processors performing steps/operations A, B, C, and D) encompasses both all such attributes or functions being mapped to all such objects and subsets of the attributes or functions being mapped to subsets of the attributes or functions (e.g., both all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors. Unless the context clearly indicates otherwise, statements that “each” instance of some collection has some property should not be read to exclude cases where some otherwise identical or similar members of a larger collection do not have the property, i.e., each does not necessarily mean each and every. Limitations as to sequence of recited steps should not be read into the claims unless explicitly specified, (e.g., with explicit language like “after performing X, performing Y,”) in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:

1. A method comprising: causing a first message to be output by a speaker of an interactive kiosk in response to detecting a first user's presence in an environment of the interactive kiosk; capturing, via at least one sensor of the interactive kiosk, first data representing a first response to the first message; deter mining, based on the first data and second data related to prior responses provided by one or more users, a similarity metric for each of the prior responses, wherein the similarity metric indicates a degree of similarity between the first response and each of the prior responses; determining, based on a first similarity metric of the similarity metrics satisfying a predefined authentication condition, a first account associated with first response; and providing, via the interactive kiosk, access to one or more services associated with the first account.
2. The method of embodiment 1, wherein the interactive kiosk comprises a financial services kiosk, a ticketing kiosk, a kiosk for accessing a secure facility, a photo kiosk, an internet kiosk, a directory/wayfinding kiosk, or an information kiosk.
3. The method of embodiment 2, wherein the interactive kiosk comprises the financial service kiosk, the financial service kiosk being an automated teller machine (ATM).
4. The method of any one of embodiments 1-3, wherein a computer system is implemented the interactive kiosk or is communicatively coupled to the interactive kiosk.
5. The method of any one of embodiments 1-4, wherein the first message comprises a greeting message output by the speaker of the interactive kiosk.
6. The method of any one of embodiments 1-5, wherein the at least one sensor of the interactive kiosk comprises at least one of one or more microphones or one or more cameras.
7. The method of any one of embodiments 1-6, wherein the first data representing the first response comprises at least one of: audio data representing a spoken reply to the first message, audio data representing sounds detected within the environment of the interactive kiosk, image data representing one or more images depicting the user within the environment of the interactive kiosk, or video data representing at least a portion of a video of the user within the environment of the interactive kiosk.
8. The method of embodiment 7, wherein at least one of the image data or the video data is used to determine at least one of: a facial expression or facial expressions exhibited by the user in connection with the outputting of the first message or a gesture or gestures performed by the user in connection with the outputting of the first message.
9. The method of any one of embodiments 7-8, wherein the audio data representing the spoken reply is used to determine an audio fingerprint of the spoken reply.
10. The method of any one of embodiments 7-8, wherein the audio data representing the sounds detected within the environment is used to determine that no reply was uttered by the user in connection with the outputting of the first message.
11. The method of any one of embodiments 1-10, wherein the one or more services comprise at least one of: financial services, ticketing services, or entrance to at least one of: a secure area, object, vehicle, or facility.
12. The method of any one of embodiments 1-11, wherein the first similarity metric satisfying the predefined authentication condition comprises: determining that the first response comprises one of a plurality of responses previously provided by the first user in response to a message output by the interactive kiosk.
13. The method of embodiment 12, wherein: the first response comprises at least one of: a facial expression of the first user exhibited in connection with the outputting of the first message, a spoken reply uttered by the first user in connection with the outputting of the first message, or gestures performed by the first user in connection with the outputting of the first message; and the plurality of responses previously provided by the first user comprise at least one of: facial expressions previously exhibited by the first user in response to a message output by the interactive kiosk, spoken replies previously uttered by the first user in response to a message output by the interactive kiosk, or gestures previously performed by the first user in response to a message output by the interactive kiosk.
14. The method of embodiment 13, wherein the first similarity metric is determined to satisfy the predefined authentication condition if the at least one of the facial expression, the spoken reply, or the gesture are determined to be similar to a respective at least one of the facial expressions previously exhibited, spoken replies previously uttered, or gestures previously performed.
15. The method of any one of embodiments 12-14, wherein the first data comprises at least one of (i) first image data representing one or more images of the first user in the environment in connection with the first message being output, or (ii) first audio data representing sounds detected in the environment in connection with the first message being output, the first similarity metric being determined to satisfy the predefined authentication condition comprises at least one of: determining, based on the second data, that at least one of the one or more images depicts the first user, or determining, based on the second data, that the sounds comprise an audio fingerprint of the first user.
16. The method of any one of embodiments 1-15, further comprising: determining information related to a location of the interactive kiosk; and generating the first message based on the information related to the location.
17. The method of embodiment 16, wherein the information related to the location of the interactive kiosk comprises at least one of: weather or forecast information related to the location, temporal information indicating a current time of at the location, or traffic information related to the location.
18. The method of embodiment 17, wherein determining the information comprises: retrieving the information related to the location from a third party system or third party service based on the location of the interactive kiosk.
19. The method of any one of embodiments 1-18, further comprising: causing a second message to be output by the speaker in response to determining that the first user ceased interacting with the interactive kiosk; capturing, via the at least one sensor, third data representing a second response to the second message; and generating training data for training a prediction model to recognize the first user based on the first data and the third data, wherein the training data comprises the first data and the third data.
20. The method of embodiment 19, wherein the second message comprises a farewell message, and determining that the user ceased interacting with the interactive kiosk comprises determining at least one of: a user is no longer within the environment of the interactive kiosk, no inputs have been detected by an input component of the interactive kiosk in a predefined amount of time, no changes in a facial expression have been detected in a predefined amount of time, no motion or gestures have been detected in a predefined amount of time, or no sounds have been detected within a predefined amount of time.
21. The method of embodiment 19, wherein the third data representing the second response comprises at least one of: audio data representing a spoken reply to the second message, audio data representing sounds detected within the environment of the interactive kiosk, image data representing one or more images depicting the user within the environment of the interactive kiosk, or video data representing at least a portion of a video of the user within the environment of the interactive kiosk.
22. The method of embodiment 21, wherein at least one of the image data or the video data is used to determine at least one of: a facial expression or facial expressions exhibited by the user in connection with the outputting of the second message or a gesture or gestures performed by the user in connection with the outputting of the second message.
23. The method of any one of embodiments 21-22, wherein the audio data representing the spoken reply is used to determine an audio fingerprint of the spoken reply.
24. The method of any one of embodiments 21-23, wherein the audio data representing the sounds detected within the environment is used to determine that no reply was uttered by the user in connection with the outputting of the second message.
25. The method of any one of embodiments 19-24, wherein the prediction model comprises at least one of: a convolutional neural network (CNN), a recurrent neural network (RNN), a depth separable CNN, or another machine-learning model.
26. The method of any one of embodiments 1-25, further comprising: causing a second message to be output by the speaker in response detecting a second user's presence in the environment of the interactive kiosk; capturing, via the at least one sensor, third data representing a second response to the second message; and in response to determining that the second user is unable to be authenticated based on the second data and the third data, causing the interactive kiosk to request additional authentication information for authenticating the second user.
27. The method of embodiment 26, wherein determining that the second user is unable to be authenticated based on the second data and the third data comprises: computing a similarity score for each of the prior responses, wherein the similarity score indicates a degree of similarity between the second response and the prior responses; and determining that none of the similarity scores satisfy the similarity score threshold or another similarity score threshold.
28. The method of any one of embodiments 26-27, wherein the additional authentication information comprises at least one of: identification information comprising at least one of: an account number of an account to be accessed, a social security number of a user attempting to access the account, a phone number of the user, an email of the user; information stored on an item to be provided to the interactive kiosk for authentication, wherein the item comprises at least one of: a credit card, an identification (ID) card, a key fob, or a near field communication (NFC) card; or biometric data comprising at least one of: a fingerprint, a palm scan, or a retinal scan.
29. The method of any one of embodiments 1-28, wherein determining the similarity metric comprises: determining a distance metric indicating the degree of similarity between the first data and the second data, wherein the similarity metric is determined to satisfy the predefined authentication condition based on the distance metric being less than or equal to a distance threshold.
30. The method of embodiment 29, wherein the distance metric to be computed is at least one of: a cosine distance, a Euclidean distance, or a Minkowski distance.
31. The method of any one of embodiments 29-30, wherein for the distance metric being a cosine distance, the distance threshold is selected from a range of 0.7-0.99.
32. The method of any one of embodiments 1-31, further comprising: causing a second message to be output by the speaker in response to determining that the first user ceased interacting with the interactive kiosk; capturing, via the at least one sensor, third data representing a second response to the second message; detecting, based on the second data and the third data, a difference between the second response and prior responses of the first user; and generating a flag indicating that suspicious behavior has been detected by the interactive kiosk, wherein the flag is stored in association with the first account.
33. The method of embodiment 32, wherein subsequent interactions with the interactive kiosk by the user associated with the first account are prevented in response to determining that the first account has the flag stored in association therewith.
34. The method of any one of embodiments 32-33, wherein the flag is removed or updated to indicate that no suspicious behavior is associated with the first account in response to the first user providing additional authentication information for authenticating the first user, wherein the additional authentication information includes at least one of: identification information, information stored on an item, or biometric information.
35. One or more tangible, non-transitory, machine-readable media storing instructions that, when executed by one or more processors, effectuation operations comprising those of any of embodiments 1-34.
36. A system comprising: one or more processors; and memory storing computer program instructions that, when executed by the one or more processors, cause the one or more processors to effectuate operations comprising those of any of embodiments 1-34.
37. An interactive kiosk comprising: one or more processors; and memory storing computer program instructions that, when executed by the one or more processors, cause the one or more processors to effectuate operations comprising those of any of embodiments 1-34.

What is claimed is:

1. A system for using passive multifactor authentication to provide access to one or more secure services, comprising:
a computer system, implemented on an automated teller machine (ATM), comprising one or more processors programmed with computer program instructions that, when executed, cause the computer system to:
cause, in response to detecting that a user is within a predefined distance of the ATM, an audio message to be output by a speaker of the ATM, wherein the audio message comprises a greeting message for the user;
capture, via a camera and microphone of the ATM, video of an environment of the ATM in connection with the outputting of the audio message;
detect, based on the captured video, a response from the user to the audio message, wherein the response comprises a facial expression of the user and a spoken reply from the user;
obtain prior response data related to prior responses provided by one or more users to previous audio messages, wherein the prior responses comprising facial expressions of the one or more users and spoken replies from the one or more users;
determine, based on the prior response data and the detected response, a similarity score indicating how similar the detected response is to the prior responses;
determine that the similarity score between the detected response and one of the prior responses satisfies a similarity score threshold;
determine an account associated with the one of the prior responses, wherein the account comprises one or more services accessible via the ATM; and
provide, via the ATM, access to the one or more services.

2. The system of claim 1, wherein prior to the audio message being output, the computer program instructions, when executed by the one or more processors, cause the computer system to:
detect that the user is within the predefined distance of the ATM;
cause a first audio message to be output by the speaker, the first audio message comprising a first greeting for the user;
capture, via the camera and the microphone, a first video of the environment in connection with the outputting of the first audio message;
cause the user to provide authentication information indicating the account;
cause a second audio message to be output by the speaker in response to detecting that the user has ceased interacting with the ATM, wherein the second audio message comprises a farewell message for the user;
capture, via the camera and the microphone, a second video of the environment in connection with the outputting of the second audio message;
store, in association with the account, (i) first data related to a first facial expression of the user and first sounds in the environment responsive to the first audio message based on the first video, and (ii) second data related to a second facial expression of the user and second sounds in the environment responsive to the second audio message based on the second video; and
generate training data for training a neural network to identify the user based on the first data and the second data, wherein the training data comprises the first data and the second data, and wherein the prior response data is generated based on the training data.

3. The system of claim 1, wherein the computer program instructions, when executed by the one or more processors, cause the computer system to:
cause, in response to detecting that the user is within the predefined distance of the ATM, a first audio message to be output by the speaker, wherein the first audio message comprises a first greeting for the user;
capture, via the camera and microphone, a video of the environment of the ATM in connection with the outputting of the first audio message;
detect, based on the captured video, a first response to the first audio message from the user;
determine, based on the first response and the prior responses, first similarity scores indicating how similar the first response is to each of the prior responses;
determine that the first similarity scores do not satisfy the similarity score threshold; and
causing the ATM to request additional authentication information to authenticate the user prior to providing access to the one or more services.

4. The system of claim 1, wherein the computer program instructions, when executed by the one or more processors, cause the computer system to:
generate training data for training a neural network to recognize the user based on at least one of the user's facial expression or the user's spoken reply to a new audio message, wherein the training data is generated based on the prior response data, the detected response, and a detected additional response to an additional audio message output by the speaker after the user ceases interacting with the ATM;
cause the neural network to be trained based on the training data to obtain a trained neural network;
provide, to the trained neural network, a subsequently detected response to a first audio message output by the speaker in response to detecting that a first user is within the predefined distance; and
obtain, from the trained neural network, an output indicating whether the first user is the user, wherein:
for the output indicating that the trained neural network classified the first user as being the user, the ATM is caused to provide the user access to the one or more services, and
for the output indicating that the trained neural network is unable to classify the first user as being the user, the ATM is caused to request additional authentication information to authenticate the first user.

5. A non-transitory computer readable medium storing computer program instructions that, when executed by one or more processors of a computing device, effectuate operations comprising:
causing a first message to be output by a speaker of an interactive kiosk in response to detecting a first user's presence in an environment of the interactive kiosk;
capturing, via at least one sensor of the interactive kiosk, first data representing a first response to the first message;
determining, based on the first data and second data related to prior responses provided by one or more users, a similarity metric for each of the prior responses, wherein the similarity metric indicates a degree of similarity between the first response and each of the prior responses;
determining, based on a first similarity metric of the similarity metrics satisfying a predefined authentication condition, a first account associated with first response; and
providing, via the interactive kiosk, access to one or more services associated with the first account.

6. The non-transitory computer readable medium of claim 5, wherein the first similarity metric satisfying the predefined authentication condition comprises:
determining that the first response comprises one of a plurality of responses previously provided by the first user in response to a message output by the interactive kiosk.

7. The non-transitory computer readable medium of claim 6, wherein the first data comprises at least one of (i) first image data representing one or more images of the first user in the environment in connection with the first message being output, or (ii) first audio data representing sounds detected in the environment in connection with the first message being output, the first similarity metric being determined to satisfy the predefined authentication condition comprises at least one of:
determining, based on the second data, that at least one of the one or more images depicts the first user; or
determining, based on the second data, that the sounds comprise an audio fingerprint of the first user.

8. The non-transitory computer readable medium of claim 5, wherein the operations further comprise:
determining information related to a location of the interactive kiosk; and
generating the first message based on the information related to the location.

9. The non-transitory computer readable medium of claim 5, wherein the operations further comprise:
causing a second message to be output by the speaker in response to determining that the first user ceased interacting with the interactive kiosk;
capturing, via the at least one sensor, third data representing a second response to the second message; and
generating training data for training a prediction model to recognize the first user based on the first data and the third data, wherein the training data comprises the first data and the third data.

10. The non-transitory computer readable medium of claim 5, wherein the operations further comprise:
causing a second message to be output by the speaker in response detecting a second user's presence in the environment of the interactive kiosk;
capturing, via the at least one sensor, third data representing a second response to the second message; and
in response to determining that the second user is unable to be authenticated based on the second data and the third data, causing the interactive kiosk to request additional authentication information for authenticating the second user.

11. The non-transitory computer readable medium of claim 5, wherein determining the similarity metric comprises:
determining a distance metric indicating the degree of similarity between the first data and the second data, wherein the similarity metric is determined to satisfy the predefined authentication condition based on the distance metric being less than or equal to a distance threshold.

12. The non-transitory computer readable medium of claim 5, wherein the operations further comprise:
causing a second message to be output by the speaker in response to determining that the first user ceased interacting with the interactive kiosk;
capturing, via the at least one sensor, third data representing a second response to the second message;
detecting, based on the second data and the third data, a difference between the second response and prior responses of the first user; and
generating a flag indicating that suspicious behavior has been detected by the interactive kiosk, wherein the flag is stored in association with the first account.

13. A method implemented on one or more processors executing computer program instructions that, when executed, perform the method, the method comprising:
causing a first message to be output by a speaker of an interactive kiosk in response to detecting a first user's presence in an environment of the interactive kiosk;
capturing, via at least one sensor of the interactive kiosk, first data representing a first response to the first message;
determining, based on the first data and second data related to prior responses provided by one or more users, a similarity metric for each of the prior responses, wherein the similarity metric indicates a degree of similarity between the first response and each of the prior responses;
determining, based on a first similarity metric of the similarity metrics satisfying a predefined authentication condition, a first account associated with first response; and
providing, via the interactive kiosk, access to one or more services associated with the first account.

14. The method of claim 13, wherein the first similarity metric satisfying the predefined authentication condition comprises:
determining that the first response comprises one of a plurality of responses previously provided by the first user in response to a message output by the interactive kiosk.

15. The method of claim 14, wherein the first data comprises at least one of (i) first image data representing one or more images of the first user in the environment in connection with the first message being output, or (ii) first audio data representing sounds detected in the environment in connection with the first message being output, the first similarity metric being determined to satisfy the predefined authentication condition comprises at least one of:
determining, based on the second data, that at least one of the one or more images depicts the first user; or
determining, based on the second data, that the sounds comprise an audio fingerprint of the first user.

16. The method of claim 13, further comprising:
determining information related to a location of the interactive kiosk; and
generating the first message based on the information related to the location.

17. The method of claim 13, further comprising:
causing a second message to be output by the speaker in response to determining that the first user ceased interacting with the interactive kiosk;
capturing, via the at least one sensor, third data representing a second response to the second message; and
generating training data for training a prediction model to recognize the first user based on the first data and the third data, wherein the training data comprises the first data and the third data.

18. The method of claim 13, further comprising:
causing a second message to be output by the speaker in response detecting a second user's presence in the environment of the interactive kiosk;
capturing, via the at least one sensor, third data representing a second response to the second message; and
in response to determining that the second user is unable to be authenticated based on the second data and the third data, causing the interactive kiosk to request additional authentication information for authenticating the second user.

19. The method of claim 13, wherein determining the similarity metric comprises:
determining a distance metric indicating the degree of similarity between the first data and the second data, wherein the similarity metric is determined to satisfy the predefined authentication condition based on the distance metric being less than or equal to a distance threshold.

20. The method of claim 13, further comprising:
causing a second message to be output by the speaker in response to determining that the first user ceased interacting with the interactive kiosk;
capturing, via the at least one sensor, third data representing a second response to the second message;
detecting, based on the second data and the third data, a difference between the second response and prior responses of the first user; and
generating a flag indicating that suspicious behavior has been detected by the interactive kiosk, wherein the flag is stored in association with the first account.
